(19) United States
(12) Patent Application Publication
(10) Pub. No.: US 2026/0291800 A1
(43) Pub. Date: Sep. 24, 2026

(54) CHANNEL ESTIMATION REFERENCE SIGNAL ON QUADRATURE AMPLITUDE MODULATION SUB-CONSTELLATION

(71) Applicant: QUALCOMM Incorporated, San Diego, CA (US)

(72) Inventors: Chih-Hao LIU, San Diego, CA (US); Jing SUN, San Diego, CA (US); Jing JIANG, San Diego, CA (US); Somsubhra BARIK, San Diego, CA (US)

(21) Appl. No.: 19/084,388

(22) Filed: Mar. 19, 2025

(51) Int. Cl. H04L 27/34; H04L 27/20; H04L 27/26

(52) U.S. Cl. CPC H04L 27/34; H04L 27/2082; H04L 27/261

(57) ABSTRACT

Various aspects of the present disclosure generally relate to wireless communication. For example, a reference signal for estimating interference or phase errors may be mapped to points in a quadrature amplitude modulation (QAM) sub-constellation to ensure that the reference signal and scheduled data have the same modulation order. For example, in a symbol of a data transmission that carries the scheduled data and the reference signal, one or more resource elements associated with the reference signal may be mapped to a quadrature phase-shift keying (QPSK) sub-constellation within a QAM constellation, such as the four outermost corner points in the QAM constellation. Additionally or alternatively, in a symbol that includes multiple REs associated with the reference signal, different reference signal tones may be mapped to different QPSK sub-constellations within the QAM constellation.

### FIELD OF THE DISCLOSURE

Aspects of the present disclosure generally relate to wireless communication and specifically relate to techniques, apparatuses, and methods associated with a channel estimation reference signal on a quadrature amplitude modulation sub-constellation.

### DESCRIPTION OF THE RELATED TECHNOLOGY

Wireless communication systems are widely deployed to provide various services, which may involve carrying or supporting voice, text, other messaging, video, data, or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, or device transmit power, among other examples). Such multiple-access RATs are supported by technological advancements that have been adopted in various telecommunication standards, which define common protocols that enable different wireless communication devices to communicate on a local, municipal, national, regional, or global level. An example telecommunication standard is New Radio (NR). NR, which also may be referred to as 5G, is part of a continuous mobile broadband evolution promulgated by the Third Generation Partnership Project (3GPP). As the demand for connectivity continues to increase, further improvements in NR may be implemented, and other RATs, such as 6G and beyond, may be introduced to enable new applications and facilitate new use cases.

In a wireless communication system, a transmitting device may use one or more modulation techniques to map a sequence of bits (for example, input bits, or information bits) to an analog signal waveform that is transmitted to a receiving device over a wireless link or channel. In some examples, the transmitting device may use a phase-shift keying (PSK) modulation technique, which may convey the sequence of binary bits in accordance with shifts in the phase of the analog signal waveform (for example, phase transitions). Additionally or alternatively, the transmitting device may use a quadrature amplitude modulation (QAM) technique, which may convey the sequence of binary bits in accordance with shifts in the amplitude and phase of the analog signal waveform. For example, a modulation order is generally associated with a two-dimensional constellation, and each bit in the sequence of binary bits is mapped to a complex modulation symbol that corresponds to a single point in the two-dimensional constellation. For example, a coordinate space for the multi-dimensional constellation may include a horizontal axis to represent an in-phase or real component of the complex modulation symbol and a vertical axis to represent a quadrature or imaginary component of the complex modulation symbol. The angle of a point in the constellation (for example, measured counterclockwise from the horizontal axis) represents a phase shift of the analog signal waveform (for example, a phase transition between symbols of the analog signal waveform), and a distance of the point from an origin of the coordinate space represents an amplitude or power of the analog signal waveform. In some examples, for PSK modulation, points in the constellation are located along a circle centered at the origin of the coordinate space, such that the points in the constellation have the same amplitude and different phases. For QAM modulation, the points in the constellation form a square with a center at the origin of the coordinate space, such that no two points in the constellation have the same amplitude and phase.

### SUMMARY

The systems, methods, and devices of this disclosure each have several innovative aspects, no single one of which is solely responsible for the desirable attributes disclosed herein.

Some aspects described herein relate to a wireless communication device. The wireless communication device may include a processing system. The processing system may include one or more processors and one or more code-storing memories coupled with the one or more processors. The processing system may be configured to cause the wireless communication device to map a set of reference signal resource elements (REs) for estimating one or more of interference or a phase associated with a wireless link to one or more sub-constellations of a quadrature amplitude modulation (QAM) constellation. The processing system may be configured to cause the wireless communication device to transmit, over the wireless link, a data message that includes one or more reference signal symbols, wherein the one or more reference signal symbols each include the set of reference signal REs mapped to the one or more sub-constellations and a set of data REs mapped to the QAM constellation.

Some aspects described herein relate to a wireless communication device. The wireless communication device may include a processing system. The processing system may include one or more processors and one or more code-storing memories coupled with the one or more processors. The processing system may be configured to cause the wireless communication device to receive, over a wireless link, a data message that includes one or more reference signal symbols, wherein the one or more reference signal symbols each include a set of reference signal REs mapped to one or more sub-constellations of a QAM constellation and a set of data REs mapped to the QAM constellation. The processing system may be configured to cause the wireless communication device to cancel one or more of interference or a phase associated with the wireless link in accordance with the set of reference signal REs.

Some aspects described herein relate to a method of wireless communication performed by a wireless communication device. The method may include mapping a set of reference signal REs for estimating one or more of interference or a phase associated with a wireless link to one or more sub-constellations of a QAM constellation. The method may include transmitting, over the wireless link, a data message that includes one or more reference signal symbols, wherein the one or more reference signal symbols each include the set of reference signal REs mapped to the one or more sub-constellations and a set of data REs mapped to the QAM constellation.

Some aspects described herein relate to a method of wireless communication performed by a wireless communication device. The method may include receiving, over a wireless link, a data message that includes one or more reference signal symbols, wherein the one or more reference signal symbols each include a set of reference signal REs mapped to one or more sub-constellations of a QAM constellation and a set of data REs mapped to the QAM constellation. The method may include cancelling one or more of interference or a phase associated with the wireless link in accordance with the set of reference signal REs.

Some aspects described herein relate to a non-transitory computer-readable medium that stores a set of instructions for wireless communication by a wireless communication device. The set of instructions, when executed by one or more processors of the wireless communication device, may cause the wireless communication device to map a set of reference signal REs for estimating one or more of interference or a phase associated with a wireless link to one or more sub-constellations of a QAM constellation. The set of instructions, when executed by one or more processors of the wireless communication device, may cause the wireless communication device to transmit, over the wireless link, a data message that includes one or more reference signal symbols, wherein the one or more reference signal symbols each include the set of reference signal REs mapped to the one or more sub-constellations and a set of data REs mapped to the QAM constellation.

Some aspects described herein relate to a non-transitory computer-readable medium that stores a set of instructions for wireless communication by a wireless communication device. The set of instructions, when executed by one or more processors of the wireless communication device, may cause the wireless communication device to receive, over a wireless link, a data message that includes one or more reference signal symbols, wherein the one or more reference signal symbols each include a set of reference signal REs mapped to one or more sub-constellations of a QAM constellation and a set of data REs mapped to the QAM constellation. The set of instructions, when executed by one or more processors of the wireless communication device, may cause the wireless communication device to cancel one or more of interference or a phase associated with the wireless link in accordance with the set of reference signal REs.

Some aspects described herein relate to an apparatus for wireless communication. The apparatus may include means for mapping a set of reference signal REs for estimating one or more of interference or a phase associated with a wireless link to one or more sub-constellations of a QAM constellation. The apparatus may include means for transmitting, over the wireless link, a data message that includes one or more reference signal symbols, wherein the one or more reference signal symbols each include the set of reference signal REs mapped to the one or more sub-constellations and a set of data REs mapped to the QAM constellation.

Some aspects described herein relate to an apparatus for wireless communication. The apparatus may include means for receiving, over a wireless link, a data message that includes one or more reference signal symbols, wherein the one or more reference signal symbols each include a set of reference signal REs mapped to one or more sub-constellations of a QAM constellation and a set of data REs mapped to the QAM constellation. The apparatus may include means for canceling one or more of interference or a phase associated with the wireless link in accordance with the set of reference signal REs.

Aspects of the present disclosure may generally be implemented by or as a method, apparatus, system, computer program product, non-transitory computer-readable medium, user equipment, network node, wireless communication device, or processing system as substantially described in the Detailed Description with reference to, and as illustrated by, the accompanying drawings. Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

Aspects of the present disclosure may generally be implemented by or as a method, apparatus, system, computer program product, non-transitory computer-readable medium, user equipment, network node, wireless communication device, or processing system as substantially described in the Detailed Description with reference to, and as illustrated by, the accompanying drawings. Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

FIG. 1 is a diagram illustrating an example of a wireless communication network.

FIG. 2 is a diagram illustrating an example disaggregated network node architecture.

FIG. 3 illustrates an example associated with a phase tracking reference signal.

FIG. 4 illustrates an example associated with an interference estimation reference signal.

FIG. 5 illustrates an example associated with a glue reference signal.

FIG. 6 illustrates an example associated with cross-layer interference in multi-user multiple-input multiple-output communication.

FIG. 7 illustrates an example associated with modulating or otherwise mapping a channel estimation reference signal on a quadrature amplitude modulation (QAM) sub-constellation.

FIG. 8 illustrates an example associated with a glue reference signal configuration across a phase jump boundary.

FIG. 9 is a flowchart illustrating an example process performed, for example, at a wireless communication device or an apparatus of a wireless communication device that supports a channel estimation reference signal on a QAM sub-constellation.

FIG. 10 is a flowchart illustrating an example process performed, for example, at a wireless communication device or an apparatus of a wireless communication device that supports a channel estimation reference signal on a QAM sub-constellation.

FIG. 11 is a diagram of an example apparatus for wireless communication that supports a channel estimation reference signal on a QAM sub-constellation.

FIG. 12 is a diagram of an example apparatus for wireless communication that supports a channel estimation reference signal on a QAM sub-constellation.

### DETAILED DESCRIPTION

In a wireless network, a signal is generally transmitted from a transmitting device to a receiving device over a wireless channel. While the signal is traveling over the wireless channel, the signal may be distorted or noise may be added to the signal due to various factors. For example, the signal may be subject to attenuation, phase shift, scattering, power decay, large scale fading, small scale fading, interference experienced by the transmitting device, interference experienced by the receiving device, or capabilities of the transmitting device or the receiving device (for example, multi-antenna capabilities or maximum transmission power), among other examples. Accordingly, in order to adapt transmission parameters or reception parameters to ensure that the signal can be received and properly decoded by the receiver node, the transmitting device or the receiving device may perform channel estimation to learn characteristics associated with the wireless channel and correct for (for example, cancel) any distortion or noise in the wireless channel.

For example, before each transmission or at periodic intervals, the wireless channel between the transmitting device and the receiving device may be learned based on, or otherwise associated with, pilot or reference signals that are transmitted over the wireless channel. For example, a downlink channel may be estimated according to a channel state information reference signal (CSI-RS) that a network node transmits to a user equipment (UE), and an uplink channel may be estimated according to a sounding reference signal (SRS) that a UE transmits to a network node. However, the state associated with a wireless channel (for example, the characteristics or properties of a wireless channel that are learned from measuring a reference signal) tends to be highly dynamic, as channel estimation may depend on factors, such as device mobility, affecting the quantity or relative positions of devices within a wireless environment, physical properties of the wireless environment surrounding the transmitter node and the receiver node (for example, objects that may reflect, scatter, or block wireless signals), or other factors.

Accordingly, in some cases, a reference signal that can be used for channel estimation may be carried within a transmission, such that a receiving device can use the reference signal to estimate the radio channel and demodulate and decode the transmission. For example, a transmission may carry a demodulation reference signal (DMRS) in certain resource blocks (RBs) allocated to the transmission, with a design and mapping that may be specific to a physical channel for which the DMRS is used for estimation. In other examples, a transmission may include a phase tracking reference signal (PTRS) that carries information used to compensate for oscillator phase noise, an interference estimation reference signal in time segments without DRMS symbols to help the receiving device estimate and cancel interference, or a glue reference signal that can be used to estimate and cancel a phase jump (for example, a change in phase) across a phase jump boundary, such as a boundary between successive slots.

However, there are circumstances where a UE may be unable to successfully cancel interference or phase errors using a PTRS, an interference estimation reference signal, or a glue reference signal. For example, in some scenarios, a PTRS, interference estimation reference signal, or glue reference signal may be configured per link, according to an interference pattern at the receiving device (for example, the network node configures the PTRS, interference estimation reference signal, or glue reference signal to fit the interference pattern at the receiving device). In a multi-user multiple-input multiple-output (MU-MIMO) scenario, where there may be cross-layer interference due to a network node concurrently transmitting one or more layers to multiple UEs, each UE may initially perform blind modulation order detection (for example, to detect whether the one or more layers were transmitted using a phase-shift keying (PSK) or quadrature amplitude modulation (QAM) modulation order), and may then perform joint decoding for the one or more layers by successively cancelling the interference or phase errors that were estimated according to the detected modulation order. However, in cases where a PTRS, interference estimation reference signal, or glue reference signal is configured per link, there may be no channel estimation reference signal configured for the transmission to one or more UEs. In such examples, the joint decoding and successive interference or phase error cancellation may fail because the modulation order at resource elements (REs) associated with the channel estimation reference signal may differ from the scheduled modulation order toward the UE communicating over the link without a PTRS, interference estimation reference signal, or glue reference signal configuration.

Various aspects relate generally to configuring a channel estimation reference signal, such as a PTRS, an interference estimation reference signal, or a glue reference signal, on a QAM sub-constellation. For example, the channel estimation reference signal may be mapped to points in a QAM sub-constellation to ensure that the channel estimation reference signal and scheduled data have the same modulation order in a data transmission. For example, in a reference signal symbol (for example, a symbol of the data transmission that carries the scheduled data and the channel estimation reference signal), one or more REs associated with the channel estimation reference signal may be mapped to a quadrature PSK (QPSK) sub-constellation within a QAM constellation, such as the four outermost corner points in a QAM constellation. Additionally or alternatively, in a reference signal symbol that includes multiple REs associated with the channel estimation reference signal, different reference signal tones may be mapped to different QPSK sub-constellations within the QAM constellation. In some aspects, where a reference signal symbol in a multi-layer transmission includes a PTRS or a glue RS (for example, a reference signal for estimating phase errors or phase changes), the reference signal may be transmitted in multiple repetitions or multiple independent streams using a quantity of ports included in a set of DMRS ports. Additionally, in cases where there is a phase jump across a boundary between successive slots in which different modulation orders are scheduled, a glue reference signal for estimating the phase jump may be mapped to a sub-constellation in which the various points have equal amplitudes and point-to-point angles, and a quantity of layers at either end of the phase jump boundary may depend on whether a DMRS is at one of the phase jump boundary or the glue reference signal is at both ends of the phase jump boundary.

Particular aspects of the subject matter described in this disclosure can be implemented to realize one or more of the following potential advantages. In some examples, by mapping reference signal REs to a sub-constellation of a QAM constellation such that the reference signal REs and scheduled data have the same modulation order within a reference signal symbol, the described techniques can be used to enable blind modulation order detection and joint decoding by successively cancelling interference or phase errors in scenarios where there is cross-layer interference at a receiving device. In addition, by mapping the reference signal REs to a sub-constellation in which the various points have equal amplitudes (for example, a QPSK sub-constellation within a QAM constellation used for data REs), the reference signal REs have the same amplitudes and therefore the same signal-to-noise ratio (SNR), which improves interference and phase estimation accuracy. Furthermore, by mapping different reference signal tones within a reference signal symbol to different sub-constellations, there is less power variation between the reference signal REs and the data REs, which may improve interference and phase estimation accuracy in cases where transmit chain nonlinearity or coherence is sensitive to total transmission power. In addition, by configuring independent or repeated streams of a PTRS or glue reference signal in a multi-layer transmission to be transmitted in a subset of DMRS ports, each PTRS or glue reference signal tone has the same quantity of layers as an active DMRS per code division multiplexing (CDM) group. In some examples, by mapping a glue reference signal to a sub-constellation in which the points have equal amplitudes and phase-to-phase angles and configuring the quantity of layers across a phase jump boundary, the glue reference signal has the waveform across the phase jump boundary, which improves phase estimation and cancellation.

5G New Radio (NR) may support enhanced mobile broadband (eMBB) access, Internet of Things (IoT) networks or reduced capability (RedCap) device deployments, ultra-reliable low-latency communication (URLLC) applications, or massive machine-type communication (mMTC), among other examples. To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive MIMO, beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial or aerial platforms, among other examples.

The methods, operations, apparatuses, and techniques described herein may enable one or more of the foregoing technologies or new technologies or support one or more of the foregoing use cases or new use cases.

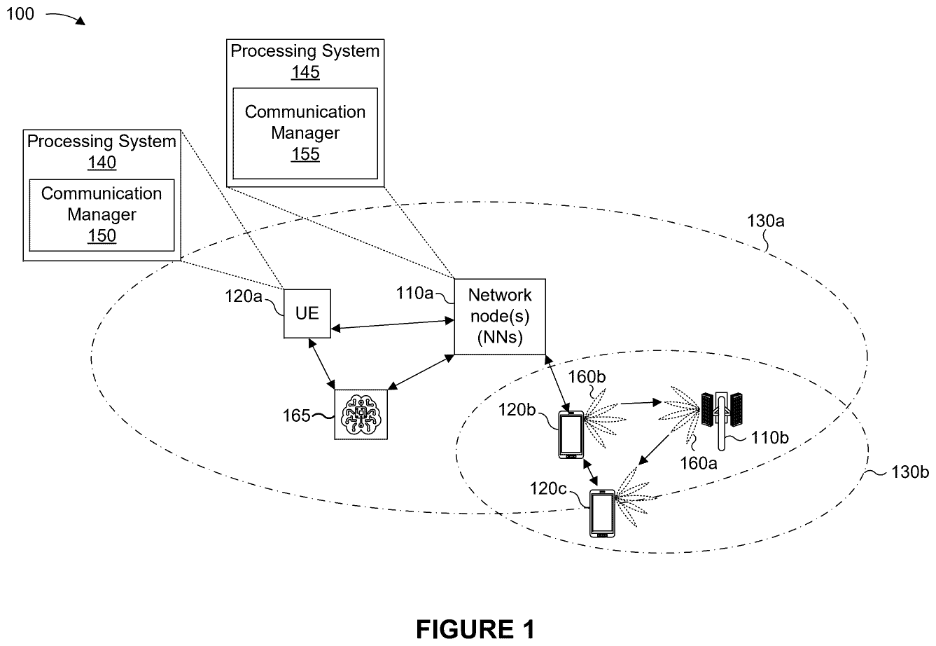

FIG. 1 is a diagram illustrating an example of a wireless communication network 100. The wireless communication network 100 may be or may include elements of a 5G network or a 6G network, among other examples. The wireless communication network 100 may include multiple network nodes 110. For example, in FIG. 1, the wireless communication network 100 includes multiple network nodes 110, including a network node 110a and a network node 110b (each of which also may be referred to herein simply as a “network node 110”). The network nodes 110 may support communications with multiple UEs 120. For example, in FIG. 1, the network nodes 110 support communication with a UE 120a, a UE 120b, and a UE 120c (each of which also may be referred to herein simply as a “UE 120”). In some examples, a UE 120 also may communicate with other UEs 120 and a network node 110 also may communicate with a core network and with other network nodes 110.

The network nodes 110 and the UEs 120 of the wireless communication network 100 communicate using the electromagnetic spectrum, which may be subdivided into various licensed or unlicensed operating bands, frequency ranges, component carriers, or channels that define associated frequencies available for communications. In some examples, each of the network nodes 110 and the UEs 120 may communicate using one or multiple component carriers in one or more operating bands or ranges. Typically, various operating bands are defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4(52.6 GHz through 114.25 GHz), and FR 5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles.

A network node 110 or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system. As shown in FIG. 1, each UE 120 includes a processing system 140 and each network node 110 includes a processing system 145. A processing system (for example, the processing system 140 or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media, such as random-access memory, or read-only memory, or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors. One or more of the memories may individually or collectively store processor-executable code or instructions (such as software) (for example, which may be referred to as “one or more code-storing memories” or “code-storing memory circuitry”). For example, “code-storing memory” or “code-storing memory circuitry” refers to memory (or memory circuitry) that is configured to store processor-executable code or instructions. The processor-executable code or instructions, when executed by one or more of the processors, may configure one or more of the processors (or processing circuitry) to perform various functions or operations described herein. Additionally or alternatively, in some examples, one or more of the processors may be configured to perform various functions or operations described herein without requiring configuration by software. Software shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 or the processing system 145 may include or implement one or more of the modems. The processing system 140 and the processing system 145 also may include or be coupled with multiple radios (collectively “the radio”), multiple RF chains, or multiple transceivers, each of which may in turn be coupled with one or more of multiple antennas. In some examples, one or more processors of the processing system 140 or the processing system 145 may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by the processing system 140 or by the processing system 145).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device, such as the network node 110 and the UE 120.

A network node 110 may be, may include, or also may be referred to as an NR network node, a 5G network node, a 6G network node, a Node B, a gNB, an access point (AP), a transmission reception point (TRP), a network entity, a network element, a network equipment, or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may include a single standalone base station or a single TRP that operates with a full radio protocol stack to enable or facilitate communication between a UE 120 and a core network of the wireless communication network 100.

Alternatively, and as also shown, a network node 110 may be a disaggregated network node 110 (sometimes referred to as a disaggregated base station), having a disaggregated architecture, meaning that the network node 110 may operate with a radio protocol stack that is physically distributed or logically distributed among two or more nodes in the same geographic location or in different geographic locations. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The disaggregated network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, or one or more RUs. In some examples, a CU, a DU, or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

In some examples, the wireless communication network 100 may be a heterogeneous network that includes network nodes 110 of various types. Different types of network nodes 110 may generally operate on the same or different operating bands, transmit at different power levels, or serve different coverage areas, each of which may be referred to as or associated with a particular cell 130 (for example, a cell 130a and a cell 130b).

The UEs 120 may be physically dispersed throughout the coverage area of the wireless communication network 100, and each UE 120 may be stationary or mobile. A UE 120 may be, may include, or also may be referred to as an access terminal, a mobile station, a client device, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), an artificially intelligent robot or other device implementing artificial intelligence, a UE function of a network node, or any other suitable device or function that may communicate in the wireless communication network 100.

Some UEs 120 may be classified according to different categories in association with different complexities or different capabilities. UEs 120 in a first category may be associated with relatively low complexity or cost such as NB-IoT devices or eMTC UEs. UEs 120 in a second category may include higher complexity or cost devices, such as mission-critical IoT devices, baseline UEs, high-tier UEs, advanced UEs, full-capability UEs, or premium UEs that are capable of URLLC, eMBB, or precise positioning in the wireless communication network 100. A third category of UEs 120 may have mid-tier complexity or capabilities (for example, capabilities between that of the UEs 120 of the first category and the UEs 120 of the second category). A UE 120 of the third category may be referred to as a reduced capability UE (“RedCap UE”), a mid-tier UE, an NR-Light UE, or an NR-Lite UE, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of RBs within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) or reconfigured (for example, in real-time or near-real-time) according to changing network conditions in the wireless communication network 100 or specific requirements of one or more UEs 120. An active BWP defines the operating bandwidth of the UE 120 within the operating bandwidth of the serving cell.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a DMRS, a PTRS, a tracking reference signal (TRS), and a CSI-RS, among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include an SRS, a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of PSK, such as binary PSK (BPSK) or QPSK, or an order of QAM, such as 64-QAM, 128-QAM, or 256-QAM, among other examples) for a downlink signal or an uplink signal. For example, the network node 110 may select an MCS for a downlink signal in accordance with UCI received from the UE 120 or may transmit, to the UE 120, an indication of an MCS to be applied for an uplink signal.

A network node 110 or a UE 120 (such as by using the processing system 145 or the processing system 140, respectively, or one or more coupled modems) may perform signal processing on the information (such as filtering, amplification, modulation, digital-to-analog conversion, an IFFT operation, multiplexing, interleaving, mapping, or encoding, among other examples) to generate a processed signal in accordance with the selected MCS. In some examples, the network node 110 or the UE 120 (for example, using the processing system 145 or the processing system 140, respectively, or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 or one or more modems) may further perform spatial processing (for example, precoding) on the encoded information to generate one or more processed or precoded signals for downlink or uplink transmission, respectively. In some examples, the network node 110a or the UE 120a may perform codebook-based precoding or non-codebook-based precoding. Codebook-based precoding may involve selecting a precoder (for example, a precoding matrix) using a codebook. For example, the network node 110a may provide precoding information indicating which precoder, defined by the codebook, is to be used by the UE 120a. Non-codebook-based precoding may involve selecting or deriving a precoder based on, or otherwise associated with, one or more downlink or uplink signal measurements. The network node 110a or the UE 120a may transmit the processed downlink or uplink signals, respectively, via one or more antennas.

The network node 110a or the UE 120a may receive uplink signals or downlink signals, respectively, via one or more antennas. The network node 110a or the UE 120a (for example, using the processing system 145 or the processing system 140, respectively, or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, or decoding, among other examples), to map the received signal(s) to a sequence of binary bits (for example, received information) that estimates the information transmitted by the network node 110 or the UE 120 via the downlink or uplink signals. The network node 110a or the UE 120a (for example, using the processing system 145 or the processing system 140, respectively, or a coupled decoder or one or more modems) may decode the received information (such as by using an ECC, a decoding operation, or an FEC operation) to detect errors or correct bit errors in the received information to generate decoded information. The decoded information may estimate the information transmitted via the downlink or uplink signals.

In some examples, a UE 120 and a network node 110 may perform MIMO communication. MIMO communication generally refers to transmitting or receiving multiple signals (such as multiple layers or multiple data streams) simultaneously over the same time and frequency resources. A network node 110 or a UE 120 may communicate using single-user MIMO or MU-MIMO, the latter of which being used by a network node 110 to simultaneously transmit signals to multiple UEs 120. MIMO techniques may involve spatial multiplexing (multi-layer transmission) or beamforming. To implement beamforming, the amplitudes or phases of signals transmitted via antenna elements may be modulated and shifted relative to each other (such as by manipulating a phase shift, a phase offset, or an amplitude) to generate one or more beams. For example, a network node 110 may generate one or more beams 160a, and a UE 120 may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with such a directional transmission or directional reception, a set of directional resources associated with a signal transmission or signal reception (for example, an angle of arrival, a horizontal direction, or a vertical direction), or a set of parameters or resources associated with one or more aspects of a directional signal, among other examples.

In some examples, a network node 110 or a UE 120 may implement massive MIMO, which may be associated with an increased (for example, “massive”) quantity of antennas at the network node 110 or at the UE 120, such as in a network implementing mmWave technology, which enables more precise beamforming or reduced interference. In some examples, the wireless communication network 100 may implement multi-TRP (mTRP) operation (including redundant transmission or reception on multiple TRPs) or non-coherent joint transmission (NC-JT).

The network node 110 and the UE 120 may establish a communication link or beam pair, and otherwise increase reliability, throughput, signal strength, or other signal properties for MIMO communications, by performing beam management operations, such as an initial beam acquisition operation, a beam refinement operation, or a beam recovery operation. For example, an initial beam acquisition operation may involve the network node 110 transmitting signals (for example, SSBs or other signals) via respective beams (for example, of the beams 160 of the network node 110) and the UE 120 receiving and measuring the signal(s) via respective beams of multiple beams (for example, from the beams 160 of the UE 120) to identify a best beam (or beam pair) for communication between the UE 120 and the network node 110. A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified or defined via one or more spatial parameters, such as a transmission configuration indicator (TCI) state or a quasi co-location (QCL) parameter, among other examples.

Some aspects and techniques as described herein may be implemented, at least in part, using an artificial intelligence (AI) program (for example, referred to herein as an “AI/ML model”), such as a program that includes a machine learning (ML) model or an artificial neural network (ANN) model. The AI/ML model may be deployed at one or more devices 165 (for example, one or more network nodes 110, one or more UEs 120, one or more servers, or one or more components of a cloud computing network, among other examples). For example, in a deployment in which AI/ML functionality is performed independently at a device 165, sometimes referred to as “overlay AI/ML,” the AI/ML model (or an instance or portion of the AI/ML model) may be deployed at a UE 120 (for example, by the processing system 140), a network node 110 (for example, by the processing system 145), one or more servers, or one or more components of a cloud computing network, among other examples. Additionally or alternatively, in a deployment where AI/ML functionality is coordinated between different devices 165, sometimes referred to as “coordinated AI/ML,” or performed at all device and network layers, sometimes referred to as “native AI/ML,” the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, or efficient use of network bandwidth, or to reduce latency, among other examples). For example, the AI/ML model(s) may be trained to identify patterns or relationships in data corresponding to the wireless communication network 100, a device, or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases, such as a self-organizing network (SON), minimization of drive test (MDT), quality of experience (QoE), positioning, sensing, predictive mobility, or traffic prediction, among other examples. In some examples, AI-as-a-Service use cases may include measurement collection reporting by a UE 120, device selection criteria (for example, according to a geographical area where measurements are to be collected or UE capabilities to be used to collected measurements), or reporting configurations (for example, reporting parameters such as location, time, or sensor information, among other examples). Additionally or alternatively, the AI/ML model(s) may enable AI/ML procedures (for example, RAN-triggered service establishment, configuration, inferencing using UE-side or network-side models, performance monitoring or management, or capability signaling, among other examples). Additionally or alternatively, the AI/ML model(s) may enable RAN-based AI/ML services via one or more application program interfaces (APIs) or management interfaces for use cases, such as beam management, radio resource monitoring (RRM) relaxation, mobility prediction, load prediction, network energy savings, or coverage and capacity improvements, among other examples.

In some aspects, the UE 120 may include a communication manager 150. As described in more detail elsewhere herein, the communication manager 150 may map a set of reference signal REs for estimating one or more of interference or a phase associated with a wireless link to one or more sub-constellations of a QAM constellation; and transmit, over the wireless link, a data message that includes one or more reference signal symbols, wherein the one or more reference signal symbols each include the set of reference signal REs mapped to the one or more sub-constellations and a set of data REs mapped to the QAM constellation. Additionally or alternatively, the communication manager 150 may receive, over a wireless link, a data message that includes one or more reference signal symbols, wherein the one or more reference signal symbols each include a set of reference signal REs mapped to one or more sub-constellations of a QAM constellation and a set of data REs mapped to the QAM constellation; and cancel one or more of interference or a phase associated with the wireless link in accordance with the set of reference signal REs. Additionally or alternatively, the communication manager 150 may perform one or more other operations described herein.

In some aspects, the network node 110 may include a communication manager 155. As described in more detail elsewhere herein, the communication manager 155 may map a set of reference signal REs for estimating one or more of interference or a phase associated with a wireless link to one or more sub-constellations of a QAM constellation; and transmit, over the wireless link, a data message that includes one or more reference signal symbols, wherein the one or more reference signal symbols each include the set of reference signal REs mapped to the one or more sub-constellations and a set of data REs mapped to the QAM constellation. Additionally or alternatively, the communication manager 155 may receive, over a wireless link, a data message that includes one or more reference signal symbols, wherein the one or more reference signal symbols each include a set of reference signal REs mapped to one or more sub-constellations of a QAM constellation and a set of data REs mapped to the QAM constellation; and cancel one or more of interference or a phase associated with the wireless link in accordance with the set of reference signal REs. Additionally or alternatively, the communication manager 155 may perform one or more other operations described herein.

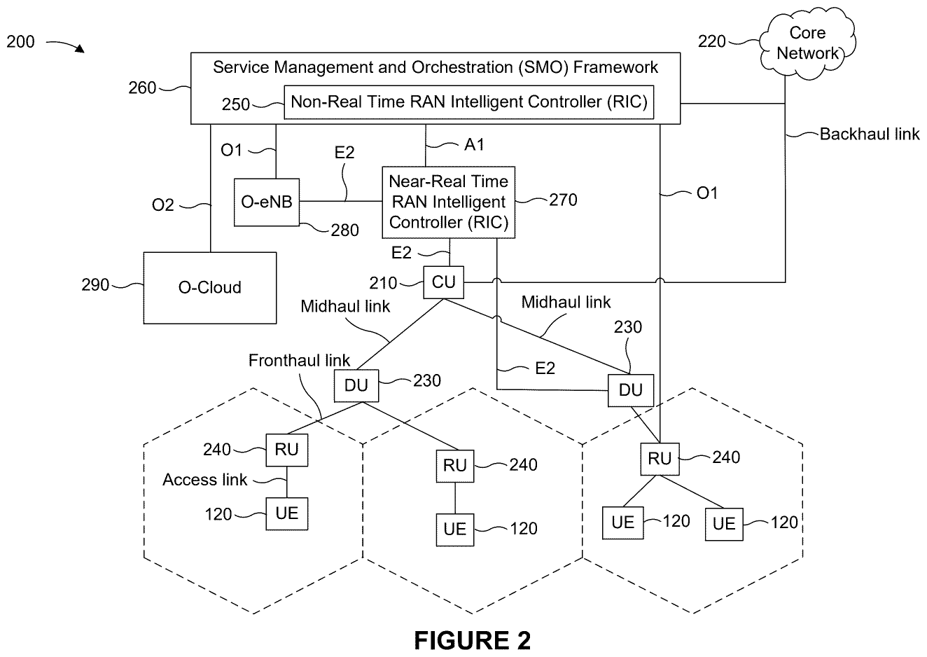

FIG. 2 is a diagram illustrating an example disaggregated network node architecture 200. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for transmitting or receiving signals, such as data, control information, or reference signals via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, or a Near-RT RIC 270. In some aspects, the SMO Framework 260 may communicate with a hardware aspect of a 4G RAN, a 5G NR RAN, or a 6G RAN, such as an open eNB (O-eNB) 280, via an O1 interface. Additionally or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, or policy-based guidance of applications or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

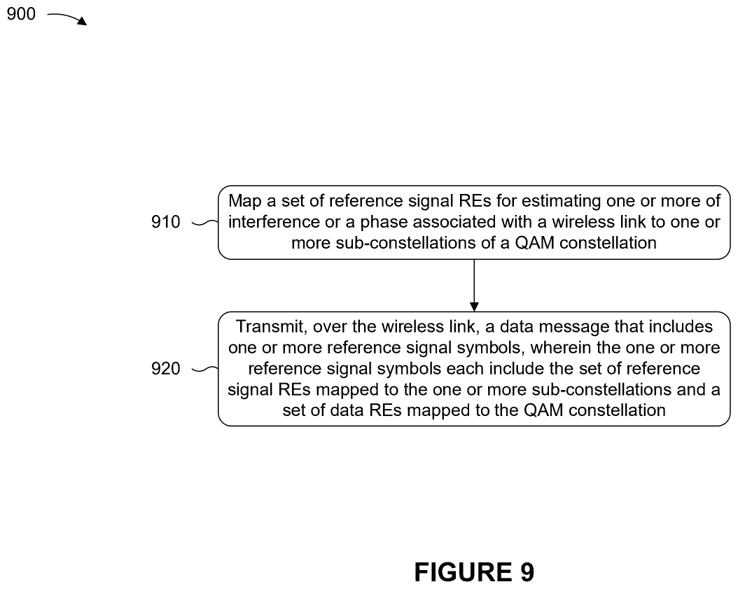

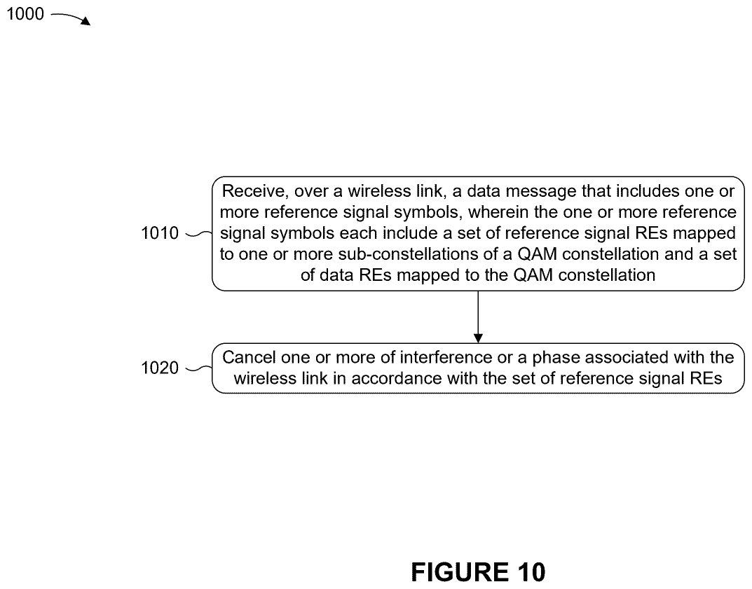

The network node 110, the processing system 145 of the network node 110, the UE 120, the processing system 140 of the UE 120, the CU 210, the DU 230, the RU 240, or any other component(s) of FIG. 1 or FIG. 2 may implement one or more techniques or perform one or more operations associated with a channel estimation reference signal on a QAM sub-constellation, as described in more detail elsewhere herein. For example, the processing system 145 of the network node 110, the processing system 140 of the UE 120, the CU 210, the DU 230, or the RU 240 may perform or direct operations of, for example, process 900 of FIG. 9, process 1000 of FIG. 10, or other processes as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 900 of FIG. 9, process 1000 of FIG. 10, or other processes as described herein. In some examples, executing instructions may include running the instructions, converting the instructions, compiling the instructions, or interpreting the instructions, among other examples.

In some aspects, a wireless communication device includes means for mapping a set of reference signal REs for estimating one or more of interference or a phase associated with a wireless link to one or more sub-constellations of a QAM constellation; or means for transmitting, over the wireless link, a data message that includes one or more reference signal symbols, wherein the one or more reference signal symbols each include the set of reference signal REs mapped to the one or more sub-constellations and a set of data REs mapped to the QAM constellation.

In some aspects, a wireless communication device includes means for receiving, over a wireless link, a data message that includes one or more reference signal symbols, wherein the one or more reference signal symbols each include a set of reference signal REs mapped to one or more sub-constellations of a QAM constellation and a set of data REs mapped to the QAM constellation; or means for cancelling one or more of interference or a phase associated with the wireless link in accordance with the set of reference signal REs.

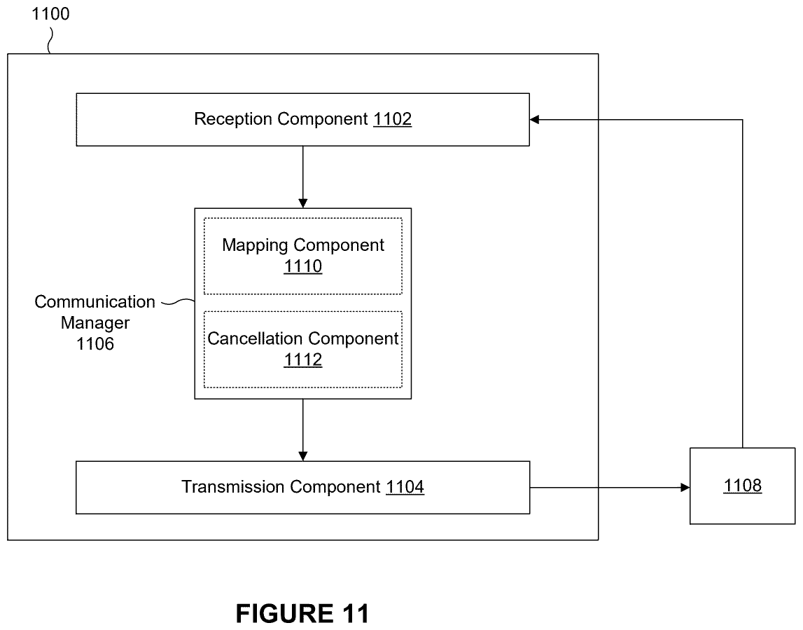

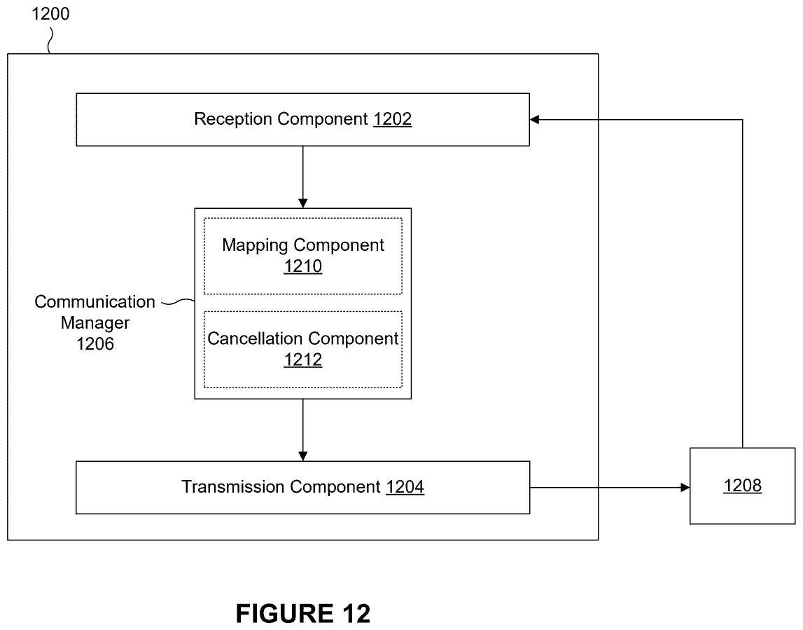

In some aspects, the wireless communication device is the UE 120, and the means for the wireless communication device to perform operations described herein may include, for example, one or more of communication manager 150, processing system 140, a radio, one or more RF chains, one or more transceivers, one or more antennas, one or more modems, a reception component (for example, reception component 1102 depicted and described in connection with FIG. 11), or a transmission component (for example, transmission component 1104 depicted and described in connection with FIG. 11), among other examples. In some aspects, the wireless communication device is the network node 110, and the means to perform operations described herein may include, for example, one or more of communication manager 155, processing system 145, a radio, one or more RF chains, one or more transceivers, one or more antennas, one or more modems, a reception component (for example, reception component 1202 depicted and described in connection with FIG. 12), or a transmission component (for example, transmission component 1204 depicted and described in connection with FIG. 12), among other examples.

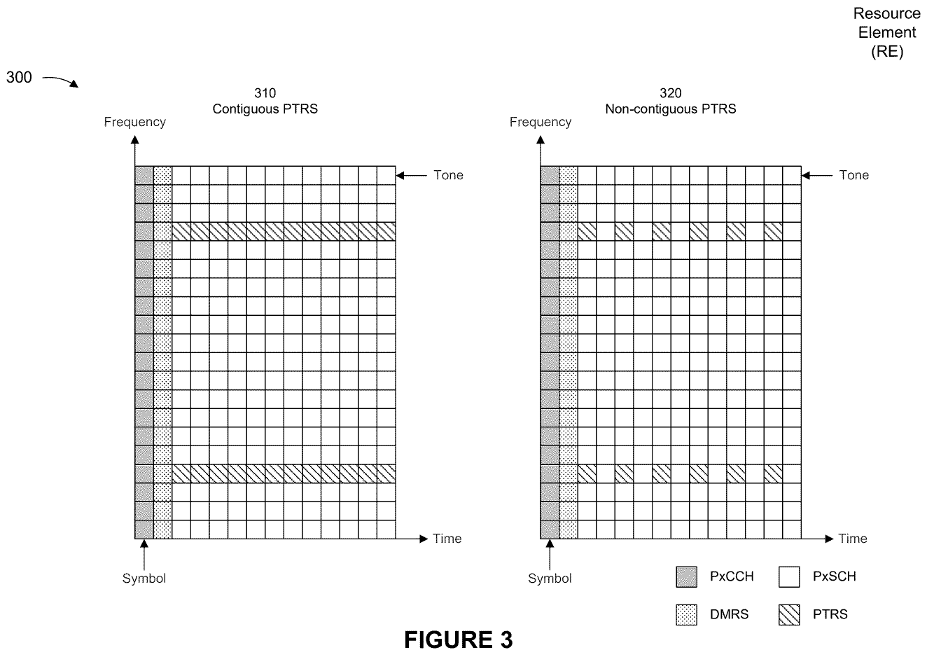

FIG. 3 illustrates an example 300 associated with a PTRS. As described herein, a PTRS carries information used to estimate and compensate for oscillator phase noise, which typically increases as the oscillator carrier frequency increases. Accordingly, a PTRS can be utilized at high carrier frequencies, such as millimeter wave frequencies, to mitigate phase noise. The PTRS may be used to track the phase of the local oscillator and to enable suppression of phase noise and common phase error (CPE), and may be used for downlink communications (within a PDSCH resource allocation) and uplink communications (within a PUSCH resource allocation).

As described herein, PTRS pilot signals (also referred to as PTRS pilot tones) may be included in a PxSCH resource allocation (for example, a PDSCH or PUSCH resource allocation) in an orthogonal frequency division multiplexing with a cyclic prefix (CP-OFDM) communication system. For a UE 120, the PTRS signals may occupy one tone or several tones in accordance with a scheduled bandwidth, an MCS, an SNR, an interference level, a port mapping, or another attribute that may impact the received signal quality of communication signals. A tone may be referred to as a subcarrier, in some aspects. Due to phase noise properties, the PTRS has a low density in a frequency domain and a high density in a time domain, and is generally configured in combination with a DMRS. For example, a PTRS may be configured to occupy the same subcarrier or tone as a DMRS (but in a different symbol), and parameters that control the time domain resources of the PTRS include the DMRS symbol locations and a time density parameter (L_{PT-RS}) with a value of 1, 2, or 4. For example, FIG. 3 illustrates a PTRS configuration 310 where PTRS pilot signals are contiguous in the time domain (for example, where the PTRS time density parameter has a value of 1), and a PTRS configuration 320 where PTRS pilot signals are non-contiguous in the time domain and hop across symbols (for example, the PTRS pilot signals are in every other symbol when the PTRS time density parameter has a value of 2, as in the PTRS configuration 320, or every fourth symbol when the PTRS time density parameter has a value of 4).

As described herein, PTRS pilot signals may be used by the UE 120 or the network node 110 for phase tracking, for phase estimation, or to correct oscillator phase noise, especially for millimeter wave communications. For example, a PTRS may be included in a PDSCH resource allocation or a PUSCH allocation, generalized herein as a PxSCH resource allocation. In some cases, one PTRS port may be configured for downlink communication (for example, within a PDSCH resource allocation), and up to two PTRS ports may be configured for uplink communication (for example, within a PUSCH resource allocation). The PTRS may use the same sequence as a corresponding DMRS, which may be a Gold sequence (for example, a QPSK modulated Gold sequence). In some aspects, a correspondence between a PTRS port and a DMRS port may be indicated to the UE 120 by a network node 110 (for example, via a DMRS-PTRS association indicated in DCI). In some cases, for uplink communications, a greater quantity of DMRS ports (for example, up to 4 DMRS ports) may be configured for a UE 120 than a quantity of PTRS ports (for example, up to 2 PTRS ports) configured for the network node 110.

Higher SNR in the PTRS pilot signals may provide a more accurate phase error estimation. Accordingly, in some aspects, the PTRS pilot signals may be located in the tones (or subcarriers) with good channel conditions, high SNR, or high signal-to-interference-plus-noise ratio (SINR), which may result in more accurate phase tracking at the UE 120. Increasing the quantity of PTRS pilot signals (for example, increasing the density in the frequency domain or the time domain) may provide more accurate phase error estimation. For example, an increased quantity of PTRS pilot signals may allow for thermal noise to be averaged out over the larger quantity of PTRS pilot signals. Additionally, an increased density of PTRS pilot signals in the frequency domain may allow for frequency diversity to be exploited. However, using a large quantity of PTRS pilot signals may increase overhead. Furthermore, the gain from increasing the quantity of PTRS pilot signals may saturate for a given quantity of PTRS pilot signals in a scheduled bandwidth. Accordingly, UEs 120 with a large scheduled bandwidth may use a sparser PTRS frequency domain pattern. Conversely, UEs 120 with a small scheduled bandwidth may use a denser PTRS frequency domain pattern. PTRS may be relatively sparse in frequency compared to DMRS. For example, one PTRS RE may appear in every other RB or every fourth RB, while 4 or 6 DMRS REs may appear in every RB. As shown in FIG. 3, the PTRS may be relatively dense in the time domain relative to the DMRS.

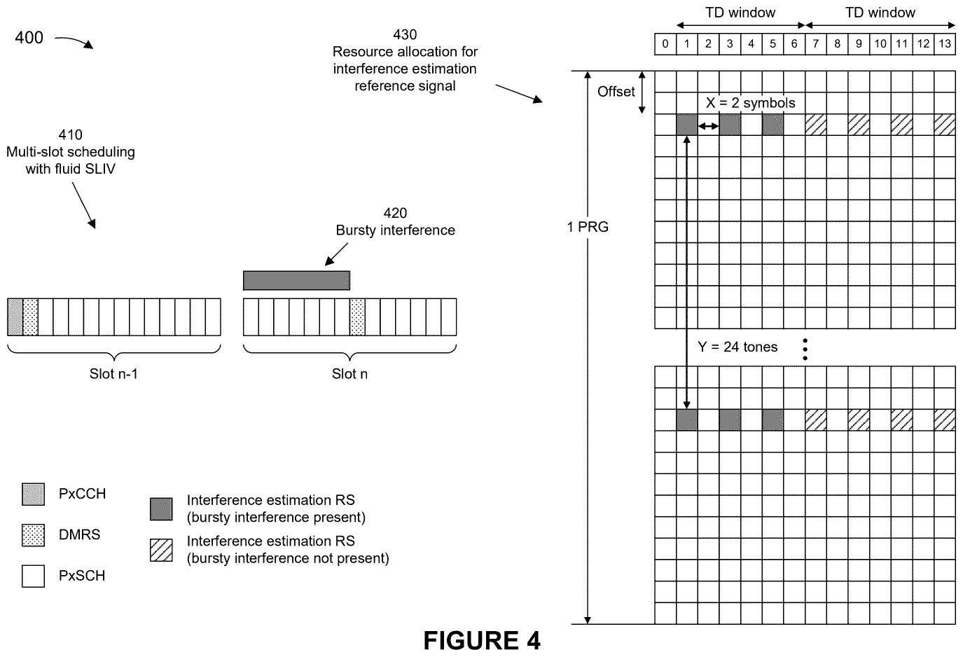

FIG. 4 illustrates an example 400 associated with an interference estimation reference signal. As described herein, the interference estimation reference signal carries information that a receiving device can use to estimate and cancel interference associated with a received transmission. For example, the interference estimation reference signal may be used in a scenario 410, where a downlink transmission or an uplink transmission may be scheduled over multiple slots with a fluid (for example, different) start and length indicator value (SLIV) and an interference pattern may vary from one slot to another. For example, as described herein, a SLIV generally indicates a starting symbol and a number of consecutive symbols for a PDSCH resource allocation or a PUSCH resource allocation in a time domain. However, when the SLIV is fluid, the DMRS used for channel estimation may appear in different symbols in different slots, which may result in the receiving device being unable to estimate and cancel interference in symbols without a DMRS. For example, in FIG. 4, a DMRS appears in the second symbol in a first slot (shown as slot n−1) and appears in the eighth symbol in the next slot (shown as slot n). Accordingly, the interference estimation reference signal may be included in the PxSCH resource allocation to enable the receiving device to estimate and cancel interference in other symbols without a DMRS, such as bursty interference 420 over symbols without a DMRS.

FIG. 4 illustrates an example resource allocation 430 for the interference estimation reference signal, which has a low density in time segments without DMRS symbols to help the receiving device estimate and cancel interference. For example, in some aspects, the interference estimation reference signal may have a similar structure as a PTRS (for example, as described above with reference to FIG. 3), and the interference estimation reference signal may occupy frequency domain and time domain resources on multiple data layers. For example, the interference estimation reference signal may occupy one or more tones per precoding RB group (PRG) according to an offset parameter that indicates a first tone occupied by the interference estimation reference signal and a frequency domain density parameter. For example, in the example resource allocation 430 shown in FIG. 4, the interference estimation reference signal has a frequency domain offset of two tones (for example, two tones separate the first interference estimation reference signal tone from a first tone in a PRG) and a frequency domain density of 24 tones (for example, the interference estimation reference signal occupies one in every 24 tones).

In some aspects, the interference estimation reference signal may have a time domain configuration per-slot on one or more symbols without a DMRS (for example, every x slots, where x is a positive integer such as 1, 2, 4, or another value). Alternatively, as shown in FIG. 4, the interference estimation reference signal may have a time domain configuration per averaging window in accordance with an interference pattern in the time domain (for example, one or more averaging windows may be configured within a slot or across multiple slots in accordance with the time domain interference pattern). For example, as shown in FIG. 4, the interference estimation reference signal is associated with two time domain averaging windows within the slot where the bursty interference 420 is present, where the first averaging window is aligned with the portion of the slot where the bursty interference 420 is present. Within each averaging window, the interference estimation reference signal may appear every x slots, where x is a positive integer such as 1, 2, 4, or another value (for example, x=2 in FIG. 4). Accordingly, the bursty interference 420 may be estimated and cancelled over the first time domain averaging window fitted to the bursty interference 420, and a second time domain averaging window spans other symbols where the bursty interference 420 is not present to improve interference estimation accuracy in each time domain averaging window.

In some aspects, the interference estimation reference signal may be configured per link. For example, a network node 110 may configure the interference estimation reference signal for PxSCH communications with a particular UE 120 in accordance with (for example, fitted to) an interference pattern at the receiver, which is the network node 110 for PUSCH communications or the UE 120 for PDSCH communication. Additionally or alternatively, the interference estimation reference signal may be configured per cell. For example, the network node 110 may configure an interference estimation reference signal for all UEs 120 served by the network node 110 in accordance with a cross-cell interference pattern (for example, fitted to an interference pattern associated with a neighboring cell). Additionally or alternatively, the interference estimation reference signal may be configured per network, such as in a scenario where interference estimation quality for a given set of reference signal tones is affected by a modulation order associated with the interference (for example, interference may be lower at lower order QAM relative to higher order QAM, such as 16-QAM versus 64-QAM or 256-QAM). In such cases, the interference estimation reference signal may be configured to occupy the same tones across multiple neighboring cells to help estimate and cancel network-wide interference.

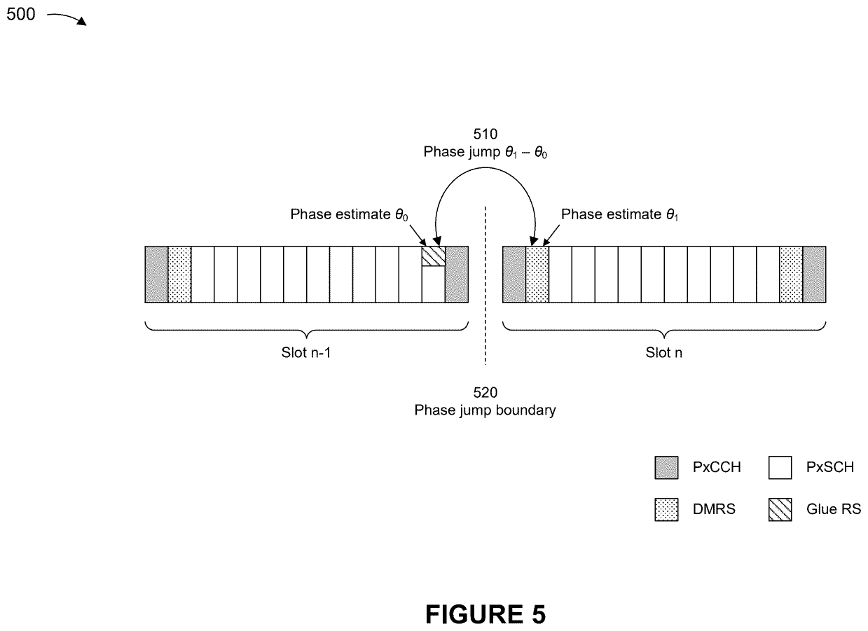

FIG. 5 illustrates an example 500 associated with a glue reference signal. As described herein, the glue reference signal carries information that a receiving device can use to estimate and cancel a phase jump 510 across a phase jump boundary 520, such as a change in phase from a symbol in a first slot to a symbol in a second slot. For example, as shown in FIG. 5, a symbol in a first slot (shown as slot n−₁) may have a first phase estimate, θ₀, and a symbol in a next slot (shown as slot n) may have a second phase estimate, θ₁, such that the phase jump 510 across a phase jump boundary 520 may be denoted θ₁-θ₀. In cases where a PxSCH resource allocation includes a DMRS on both sides of the phase jump boundary 520, the DMRS at both ends of the phase jump boundary 520 may enable the receiving device to measure the phase jump 510. However, in cases where there is a large time domain separation between the DMRS and the phase jump boundary 520 on one or both sides of the phase jump boundary 520, any phase change that the receiving device measures according to the DMRS may be indistinguishable from a phase change due to Doppler effects.

Accordingly, as shown in FIG. 5, a glue reference signal may be configured around the phase jump boundary 520 (for example, in cases where a time domain separation between a DMRS and the phase jump boundary 520 satisfies a threshold on one or both sides of the phase jump boundary 520). In some aspects, the glue reference signal may generally serve a similar function to a PTRS (for example, estimating and cancelling phase errors), and therefore may have a frequency domain density similar to a PTRS. For example, in some aspects, the glue reference signal may occupy one RE in every other RB or one RE in every fourth RB, and punctures the associated PxSCH. In the time domain, the glue reference signal may be configured to occupy one or more reference signal symbols that are as close as possible to the phase jump boundary 520, depending on whether a DMRS is available at one end of the phase jump boundary 520. For example, in FIG. 5, the symbol immediately prior to the phase jump boundary 520 (the last symbol in slot n−1) is allocated to control information, whereby the glue reference signal occupies the second-to-last symbol in the slot prior to the phase jump boundary 520. However, in the slot after the phase jump boundary 520, the first symbol is allocated to control information, and the next symbol is allocated to a DMRS. Accordingly, the DMRS can be used at the other end of the phase jump boundary 520.

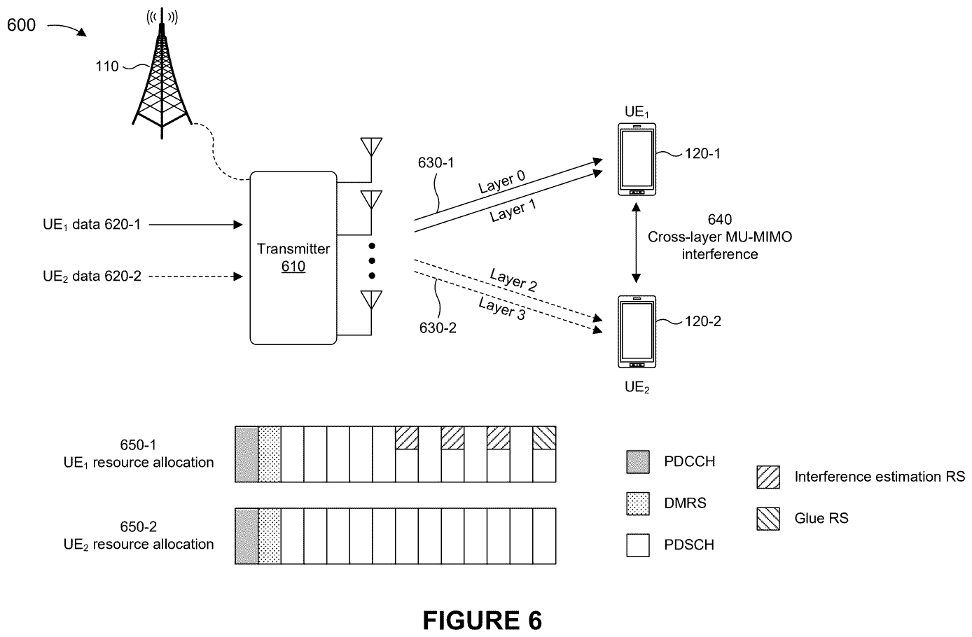

FIG. 6 illustrates an example 600 associated with cross-layer interference in MU-MIMO communication. For example, in the MU-MIMO configuration shown in FIG. 6, a network node 110 may be equipped with a transmitter 610 used to simultaneously transmit signals to multiple UEs 120, such as a first UE 120-1 and a second UE 120-2, using beamforming, spatial diversity (for example, spatial multiplexing), or polarization diversity (for example, polar multiplexing). The network node 110 may transmit data 620-1 for the first UE 120-1 (shown with solid lines) via a first set of layers 630-1 (shown as layer 0 and layer 1), and may concurrently transmit data 620-2 for the second UE 120-2 (shown with dashed lines) via a second set of layers 630-2 (shown as layer 2 and layer 3). The signals that form the first set of layers 630-1 and the signals that form the second set of layers 630-2 may be simultaneously emitted from a set of antennas associated with the transmitter 610. The first set of layers 630-1 and the second set of layers 630-2 may use different carrier frequencies, may use the same carrier frequency, may use different air interface resources, or may use the same air interface resource. The first UE 120-1 and the second UE 120-2 may include a single antenna port or multiple antenna ports, and each antenna port may be associated with one or more antennas of the respective UE 120.

In an MU-MIMO configuration, reference signals and channels may have different assignments within resource allocations for different UEs, such as the first UE 120-1 and the second 120-2. For example, as described herein, a PTRS, interference estimation reference signal, or glue reference signal may be configured per link (for example, for one or more UEs 120 in accordance with link-specific conditions), per cell (for example, for all UEs 120 in a cell in accordance with cell-specific conditions), or per network (for example, across neighboring cells). For example, FIG. 6 illustrates reference signal configurations per link, where a first resource allocation 650-1 for the first UE 120-1 configures an interference estimation reference signal in three symbols and a glue reference signal in one symbol, and a second resource allocation 650-2 for the second UE 120-2 does not include any interference estimation or glue reference signal. In such cases, the second UE 120-2 may be unable to estimate and cancel cross-layer MU-MIMO interference 640 (for example, where the transmission to the second UE 120-2 interferes with the transmission to the first UE 120-1).

For example, the second UE 120-2 initially performs blind modulation order detection for the first set of layers 630-1 transmitted to the first UE 120-1 (for example, to detect whether the first set of layers 630-1 were transmitted using a PSK modulation order such as QPSK or a QAM modulation order such as 16-QAM). After detecting the modulation order for the first set of layers 630-1, the second UE 120-1 performs joint decoding for the second set of layers 630-2 by successively cancelling estimated interference associated with the first set of layers 630-1. In other words, the joint decoding of the second set of layers 630-2 and the successive interference cancellation of the first set of layers 630-1 may depend on the second UE 120-2 correctly detecting the modulation order the first set of layers 630-1. However, in cases where a PTRS, interference estimation reference signal, or glue reference signal is configured per link (for example, configured in the resource allocation 650-1 for the first UE 120-1, but not configured in the resource allocation 650-2 for the second UE 120-1), the modulation order at the REs where the PTRS, interference estimation reference signal, or glue reference signal are configured may differ from the scheduled modulation order toward the second UE 120-1. For example, the modulation order at the REs where the PTRS, interference estimation reference signal, or glue reference signal are configured in the first resource allocation 650-1 may be QPSK, and the data scheduled toward the second UE 120-2 may have a different modulation order (for example, a QAM modulation).

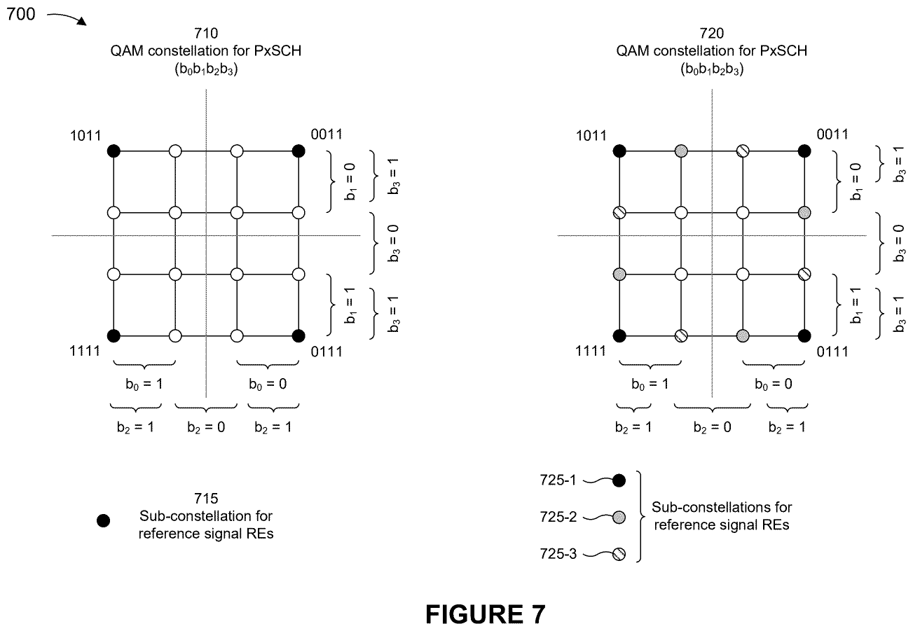

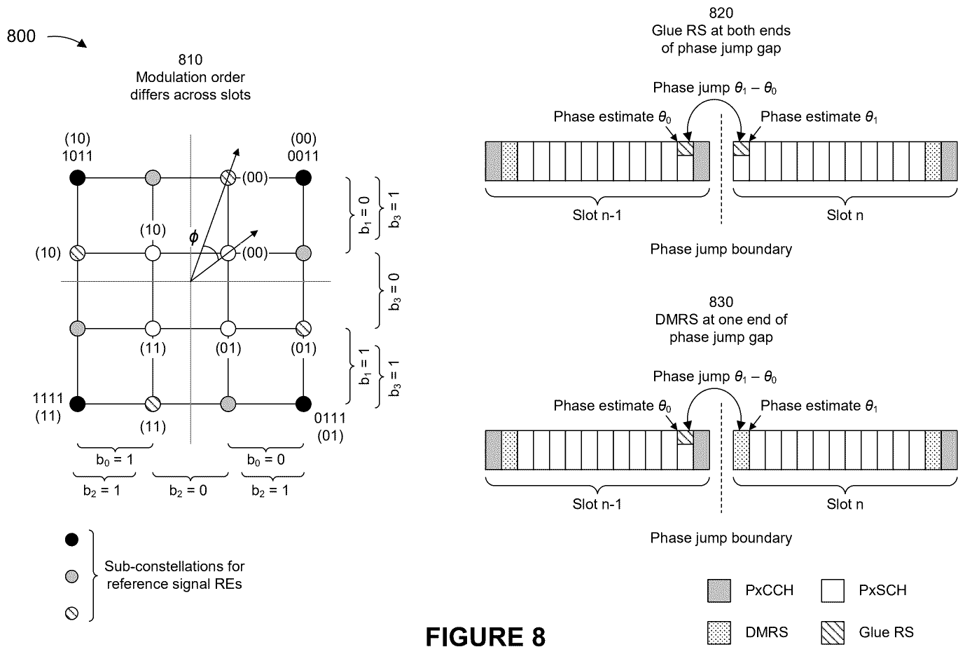

Accordingly, as described in further detail with reference to FIGS. 7-8, various aspects relate generally to configuring a channel estimation reference signal, such as a PTRS, an interference estimation reference signal, or a glue reference signal, on a QAM sub-constellation. For example, the channel estimation reference signal may be mapped to points in a QAM sub-constellation to ensure that the channel estimation reference signal and scheduled data have the same modulation order in a data transmission. For example, in a reference signal symbol (for example, a symbol of the data transmission that carries the scheduled data and the channel estimation reference signal), one or more REs associated with the channel estimation reference signal may be mapped to a QPSK sub-constellation within a QAM constellation, such as the four outermost corner points in a QAM constellation. Additionally or alternatively, in a reference signal symbol that includes multiple REs associated with the channel estimation reference signal, different reference signal tones may be mapped to different QPSK sub-constellations within the QAM constellation. In some aspects, where a reference signal symbol in a multi-layer transmission includes a PTRS or a glue RS (for example, a reference signal for estimating phase errors or phase changes), the reference signal may be transmitted in multiple repetitions or multiple independent streams using a quantity of ports included in a set of DMRS ports. Additionally, in cases where there is a phase jump across a boundary between successive slots in which different modulation orders are scheduled, a glue reference signal for estimating the phase jump may be mapped to a sub-constellation in which the various points have equal amplitudes and point-to-point angles, and a quantity of layers at either end of the phase jump boundary may depend on whether a DMRS is at one of the phase jump boundary or the glue reference signal is at both ends of the phase jump boundary.

FIG. 7 illustrates an example 700 associated with modulating or otherwise mapping a channel estimation reference signal on a QAM sub-constellation. For example, FIG. 7 illustrates example QAM constellations 710 and 720 that includes various complex modulation symbols arranged in a coordinate space that includes a horizontal axis to represent an in-phase or real component of the complex modulation symbol and a vertical axis to represent a quadrature or imaginary component of the complex modulation symbol. As described herein, the points in a QAM constellation form a square grid with equal horizontal and vertical spacings (although other configurations, such as hexagonal or triangular are possible). The quantity of points in a square QAM constellation is an even power of 2 corresponding to the order of QAM, such as 16 points for 16-QAM, 64 points for 64-QAM, or 256 points for 256-QAM, and the quantity of points in the grid is a power of 2 corresponding to the quantity of bits that are conveyed per complex modulation symbol.

For example, QAM constellations 710 and 720 shown in FIG. 7 are for 16-QAM, whereby the QAM constellations 710 and 720 have 2⁴ (sixteen) total points, and each point in the QAM constellations 710 and 720 conveys 4 bits. For example, each point represents a four-bit binary value, denoted b₀b₁b₂b₃, where the most significant bit (b₀) has a value of 1 for the first two columns or 0 for the last two columns, the next most significant bit (b₁) has a value of 0 for the first two rows or 1 for the last two row, the next most significant bit (b₂) has a value of 1 for the first and fourth column or 0 for the middle two columns, and the least significant bit (b₃) has a value of 1 for the first and fourth rows or 0 for the middle two rows. Accordingly, because each point in a QAM constellation has a unique combination of phase and amplitude (where the angle of a point, measured counterclockwise from the horizontal axis, represents the phase and the distance from the origin of the coordinate space or center of the constellation represents the amplitude), a transmitting device can modulate the phase and amplitude of a transmitted signal to encode a sequence of bits, and a receiving device can demodulate the phase and amplitude of a received signal to recover the sequence of bits. For example, a UE 120 may modulate a signal according to a QAM constellation to transmit uplink data in a PUSCH message to a network node 110, and a network node 110 may modulate a signal according to a QAM constellation to transmit downlink data in a PDSCH message to a UE 120. Alternatively, a transmitting device may transmit a PxSCH message using QPSK modulation, which is associated with a constellation having 4 points arranged in a circle (for example, the 4 points have equal amplitudes and respective phases that are separated by 90 degrees).

In a communication scenario associated with cross-layer interference, such as MU-MIMO, a transmission to a first receiving device may be mapped to a QAM constellation and a transmission to a second receiving device may be mapped to a QPSK constellation, which may pose interference cancellation and decoding challenges when a PTRS, interference estimation reference signal, or glue reference signal is configured only for the transmission to the second receiving device. For example, because a QPSK constellation includes 4 points that are equidistant from the center, the points in a QPSK constellation overlap with points in a QAM constellation (for example, the 4 outermost corner points). As a result, the first receiving device may be unable to distinguish some data tones in the transmission to the first receiving device from the PTRS, interference estimation reference signal, or glue reference signal tones in the transmission to the second receiving device.

Accordingly, in some aspects, a transmitting device (for example, a network node 110 or a UE 120) may map a channel estimation reference signal, such as a PTRS, an interference estimation reference signal, or a glue reference signal, to a QAM sub-constellation that corresponds to a subset of the points in a QAM constellation associated with a scheduled PxSCH. For example, the REs associated with the channel estimation reference signal may be mapped to 4 constellation points that are a sub-constellation of a QAM constellation. In this way, from the perspective of the intended receiving device, the REs associated with the channel estimation reference signal are associated with QPSK modulation, and may appear to be associated with a QAM constellation to another (victim) device attempting to cancel cross-layer interference. For example, as shown in FIG. 7, the channel estimation reference signal may be transmitted in a sub-constellation 715 that corresponds to the 4 corner points in the QAM constellation 710. Although the channel estimation reference signal may be transmitted in any 4-point sub-constellation of the QAM constellation 710, the corner points are farthest from the center of the QAM constellation 710, and therefore have the largest amplitudes. Accordingly, the sub-constellation 715 corresponding to the 4 corner points may result in the channel estimation reference signal REs having a larger SNR compared to channel estimation reference signal REs mapped to inner points of the QAM constellation 710 or other points that have smaller amplitudes. In this way, mapping the channel estimation reference signal REs to the sub-constellation 715 may improve interference estimation or phase estimation performance relative to other sub-constellations of the QAM constellation 710. Furthermore, although the QAM constellations 710 and 720 shown in FIG. 7 are for 16-QAM, aspects described herein can be suitably applied to QAM constellations associated with higher order QAM.

As described herein, in a reference signal symbol (for example, a symbol in a PxSCH allocation that includes one or more PTRS, interference estimation reference signal, or glue reference signal REs in addition to data REs), a transmitting device may map the reference signal REs to a 4-point sub-constellation of a QAM constellation. In the example where the sub-constellation 715 corresponds to the corner points in the QAM constellation 710, the reference signal REs could have a higher average power than the data REs because the corner points have the largest amplitudes. In some aspects, the reference signal REs may be permitted to have a higher average power than the data REs in cases where the reference signal has a small density in the frequency domain (for example, a few tones or a small percentage of tones over an entire PxSCH allocation). Alternatively, in cases where the reference signal has a relatively larger density in the frequency domain (for example, to overcome conditions such as transmit chain nonlinearity or coherence being sensitive to total transmission power), different reference signal tones may be mapped to different sub-constellations associated with different average powers (or amplitudes).

For example, in some aspects, the QAM constellation 720 may include a first sub-constellation 725-1 shown with a black fill, a second sub-constellation 725-2 shown with a gray fill, and a third sub-constellation 725-3 shown with a diagonal fill. For example, as shown, the first sub-constellation 725-1 corresponds to the 4 corner points, the points forming the second sub-constellation 725-2 are each shifted one step from the first sub-constellation 725-1 in a clockwise direction (for example, from 1011 to 1001, from 0011 to 0010, from 0111 to 0101, and from 1111 to 1110), and the points forming the third sub-constellation 725-3 are each shifted one step from the first sub-constellation 725-1 in a counter-clockwise direction (for example, from 1011 to 1010, from 0011 to 0001, from 0111 to 0110, and from 1111 to 1101). Accordingly, in cases where a reference signal symbol includes multiple reference signal REs, different reference signal tones (or REs) within the symbol may be mapped to different sub-constellations 725. For example, the transmitting device may cycle through the different sub-constellations 725 when mapping the reference signal tones in a reference signal symbol, or may map the reference signal tones to different sub-constellations 725 according to any suitable pattern. In this way, there may be less power variation across the reference signal symbol relative to using only the 4 corner points.

In some aspects, in cases where the PTRS, interference estimation reference signal, or glue reference signal included in a PxSCH are transmitted using multiple layers (or streams), the transmitting device may transmit the multiple layers with the same precoding. For a PDSCH message that includes a phase estimation reference signal (for example, a PTRS or glue reference signal), or a phase estimation reference signal included within a PUSCH message associated with a port coherence group, the phase estimation reference signal may be transmitted in a virtual port (for example, in all active DMRS ports within each DMRS CDM group associated with a link). Furthermore, in some aspects, the phase estimation reference signal may be repeated in all active DMRS ports within each DMRS CDM group associated with a link. Although each tone of the phase estimation reference signal has the same quantity of layers as the active DMRS per CDM group (for example, to match the DMRS, where different DMRS ports may be frequency division multiplexed), the tones of the phase estimation reference signal may have a different quantity of layers from the PxSCH.

Accordingly, in some aspects, in a multi-layer PxSCH transmission, a phase estimation reference signal (for example, a PTRS or glue reference signal) included in the PxSCH resource allocation may be transmitted in L streams in L reference signal ports that are associated with K DMRS ports, where L is a positive integer having a value greater than one, K is the number of data layers, and L is less than or equal to K such that the quantity of reference signal streams and corresponding ports does not exceed the quantity of DMRS ports or data layers. In some aspects, the quantity of reference signal streams and ports may equal the quantity of data layers and DMRS ports (for example, L=K) such that joint demodulation of the PxSCH and the phase estimation reference signal is associated with the same quantity of layers of interferences among data and reference signal REs. Furthermore, in some aspects, the L reference signal layers may be associated with a repetition of a symbol in a sub-constellation of a QAM constellation over the L reference signal layers. In such cases, the transmitting device generates only one random sequence associated with a QPSK modulation per reference signal RE, and the modulated sub-constellations of the QAM constellation are repeated in each of the L layers. Alternatively, in some aspects, the L reference signal layers may be associated with independent streams of symbols in the sub-constellation of the QAM constellation. In such cases, the transmitting device independently generates L random sequences associated with a QPSK modulation per reference signal RE (for example, using layer-dependent seeds or L longer random sequences), where the L independent random sequences are mapped to L sub-constellations of the QAM constellation. For a glue reference signal to estimate a phase jump across a phase jump boundary, different streams of the glue reference signal may be mapped to the same sub-constellation (for example, to allow phase jump estimation from two glue reference signal symbols with different modulation orders).

FIG. 8 illustrates an example 800 associated with a glue reference signal configuration across a phase jump boundary. In particular, as described herein, a glue reference signal is generally designed to assist a receiving device with DMRS combining and joint channel estimation across a phase jump boundary (for example, a point in time where a symbol prior to the phase jump boundary has a different phase from a symbol after the phase jump boundary). Accordingly, any channel estimation obtained in the last few symbols prior to the phase jump boundary are not available (or not accurate) after the phase jump boundary in a Doppler scenario, and the glue reference signal may be provided to enable joint phase and channel estimation (possibly leveraging a DMRS) across the phase jump boundary. However, in some cases (for example, intra-UE and inter-UE downlink scheduling) using cross-SLIV or slot combining, different modulation orders may be scheduled in successive slots, which may result in different reference signal waveforms across the phase jump boundary.

For example, FIG. 8 illustrates an example scenario 810 where glue reference signal symbols are associated with different QAM modulation orders in successive slots, which may occur in cross-SLIV DMRS sharing or other scenarios. For example, in the scenario 810, the glue reference signal may be mapped to the four inner points in a first slot on one side of the phase jump boundary (for example, corresponding to QPSK modulation), and may be mapped to a sub-constellation of a 16-QAM constellation in a second slot on the other side of the phase jump boundary. In cases where the 4-point sub-constellation of the 16-QAM constellation is a sub-constellation other than the 4 corner points (for example, the 4 points shifted one step from the corner points in a counter-clockwise direction), a glue reference signal symbol in a slot prior to the phase jump boundary has a different phase from a glue reference signal symbol in a slot after the phase jump boundary. Accordingly, in some aspects, a transmitting device may select 4-point sub-constellations of a QAM constellation in which the points have equal amplitudes and equal point-to-point angles (for example, 45 degrees counter-clockwise), and may assign QPSK symbols counter-clockwise in the same order. In this way, different sub-constellations that are used across a phase jump boundary may have a common phase rotation (φ) that can be compensated despite a different modulation order being used across the phase jump boundary. For example, in the scenario 810 shown in FIG. 8, a QPSK modulation order may be used in a slot on one side of the phase jump boundary, and a 16-QAM sub-constellation including the 4 points shifted one step from the corner points in a counter-clockwise direction may be used in a slot on the other side of the phase jump boundary, resulting in a common phase φ between the two sub-constellations associated with two different MCSs.

Across different SLIVs or slots, a receiving device may be made aware of the modulation order and the sub-constellation associated with a given reference signal tone across a phase jump boundary. For example, in downlink scheduling, a network node 110 may indicate the modulation orders and the sub-constellations associated with a given reference signal tone across the phase jump boundary to a UE 120. In this way, the receiving device may identify a phase offset between the sub-constellations before estimating the phase jump. For example, xᵢ may represent a reference signal for layer i prior to a phase jump boundary, and hᵢ may represent a frequency channel response at the reference signal tone for layer i. In cases where the receiving device is able to identify the phase offset between sub-constellations used before and after a phase jump boundary, a reference signal for layer i after the phase jump boundary may be denoted \tilde{x}ᵢ=xᵢ·α·e^{jφ}, and a reference signal tone after the phase jump boundary may be represented by e^{jθ}^{₁}·(ĥ₀·\tilde{x}₀+ĥ₁·\tilde{x}₁)=αe^{jφ}e^{jθ}₁(ĥ₀x₀+ĥ₁x₁) (where the reference signal tone is y=e^{jθ}₀(h₀x₀+h₁x₁) before the phase jump boundary). In this example, α and e^{jφ} are known values, which allows the receiving device to identify the QAM sub-constellations for two glue reference signal REs across a phase jump boundary (for example, because the modulation order and frequency domain resource allocation for intra-UE cross-SLIV DMRS sharing are provided in the scheduling DCI).

Accordingly, when a different modulation order is used prior to and after a phase jump boundary, a transmitting device may select only 4-point sub-constellations in which the points have equal amplitudes and point-to-point angles. For example, a point-to-point angle between the two sub-constellations may be 45 degrees or another suitable angle in a clockwise direction or a counter-clockwise direction. Furthermore, to enable the receiving device to estimate and cancel the phase jump, the reference signal bits may be mapped to the same QPSK sequence across the phase jump boundary. Alternatively, the two-bit QPSK sequence associated with the reference signal may be mapped to different sub-constellations in the same order, clockwise or counter-clockwise. For example, starting from the horizontal axis, the QPSK sequence at point (x, y) may be mapped to the sub-constellations across the phase jump boundary in the same order for the different modulation orders, clockwise or counter-clockwise. For example, two points associated with QPSK sequence (x₀, y₀) from two different sub-constellations associated with different modulation orders have the same phase difference compared to another two points associated with QPSK sequence (x₁, y₁).

In some aspects, across a phase jump boundary, two glue reference signal REs may have the same quantity of layers before and after the phase jump boundary. For a fluid SLIV, where the SLIV may differ before and after the phase jump boundary, the quantity of layers is constant, which results in two glue reference signal REs having the same quantity of layers before and after the phase jump boundary. However, for cross-SLIV DMRS combining, successive slots may be scheduled with different quantities of layers. In a first scenario 820, where a glue reference signal is at both ends of the phase jump boundary, slots associated with different SLIVs may be scheduled to have the same quantity of glue reference signal layers. However, in a second scenario 830, where a DMRS is at one end of the phase jump boundary, the slot with the DMRS may have more layers than the slot with the glue reference signal, provided that the DMRS ports are a superset of the ports associated with the glue reference signal. For example, in scenario 830, a PxSCH transmitted in the slot prior to the phase jump boundary may be transmitted with DMRS ports 0, 1, and 2, and a PxSCH transmitted in the slot after the phase jump boundary may be transmitted with DMRS ports 0 and 1. In this example, in the slot prior to the phase jump boundary, the receiving device can reconstruct (ĥ₀x₀+ĥ₁x₁) from a first channel estimation pass according to a front-loaded DMRS (for example, the DMRS at the beginning of the slot) and perform joint phase jump and channel estimation with DMRS combining across the boundary.

Accordingly, when a different modulation order is used prior to and after a phase jump boundary and a glue reference signal is at both ends of the phase jump boundary, such as in scenario 820, the two glue reference signal symbols may have the same quantity of layers and may be associated with the same set of DMRS ports prior to and after the phase jump boundary. For example, to enable phase jump estimation with multi-layer QAM sub-constellations, the same set of glue reference signal ports may be transmitted across the phase jump boundary gap. In some aspects, the quantity of glue reference signal layers in a slot on one side of the phase jump boundary may be smaller than the quantity of data layers, which sacrifices one bit in the inter-layer interference cancellation in an MU-MIMO joint modulation configuration only at the glue reference signal REs. Alternatively, when a different modulation order is used prior to and after a phase jump boundary and a DMRS is at one end of the phase jump boundary and a glue reference signal at the other end of the phase jump boundary, such as in scenario 830, the DMRS may have more layers than the glue reference signal, provided that the DMRS ports are a superset of the ports associated with the glue reference signal.

FIG. 9 is a flowchart illustrating an example process 900 performed, for example, at a wireless communication device or an apparatus of a wireless communication device that supports a channel estimation reference signal on a QAM sub-constellation. Example process 900 is an example where the apparatus or the wireless communication device (for example, UE 120 or network node 110) performs operations associated with modulating or otherwise mapping a channel estimation reference signal on a QAM sub-constellation.

As shown in FIG. 9, in some aspects, process 900 may include mapping a set of reference signal REs for estimating one or more of interference or a phase associated with a wireless link to one or more sub-constellations of a QAM constellation (block 910). For example, the wireless communication device (such as by using communication manager 1106 or mapping component 1110, depicted in FIG. 11, or by using communication manager 1206 or mapping component 1210, depicted in FIG. 12) may map a set of reference signal REs for estimating one or more of interference or a phase associated with a wireless link to one or more sub-constellations of a QAM constellation, as described above.

As further shown in FIG. 9, in some aspects, process 900 may include transmitting, over the wireless link, a data message that includes one or more reference signal symbols, wherein the one or more reference signal symbols each include the set of reference signal REs mapped to the one or more sub-constellations and a set of data REs mapped to the QAM constellation (block 920). For example, the wireless communication device (such as by using communication manager 1106 or transmission component 1104, depicted in FIG. 11, or by using communication manager 1206 or transmission component 1204, depicted in FIG. 12) may transmit, over the wireless link, a data message that includes one or more reference signal symbols, wherein the one or more reference signal symbols each include the set of reference signal REs mapped to the one or more sub-constellations and a set of data REs mapped to the QAM constellation, as described above.

Process 900 may include additional aspects, such as any single aspect or any combination of aspects described below or in connection with one or more other processes described elsewhere herein.

In a first additional aspect, the set of reference signal REs includes at least a first reference signal RE mapped to a first sub-constellation and a second reference signal RE mapped to a second sub-constellation.

In a second additional aspect, alone or in combination with the first aspect, the data message includes a plurality of layers in which a quantity of ports used to transmit the set of reference signal REs is equal to a quantity of the plurality of layers and less than or equal to a quantity of DMRS ports.

In a third additional aspect, alone or in combination with one or more of the first and second aspects, the plurality of layers corresponds to a plurality of repetitions of the one or more sub-constellations.

In a fourth additional aspect, alone or in combination with one or more of the first through third aspects, the plurality of layers corresponds to a plurality of independent streams of the one or more sub-constellations.

In a fifth additional aspect, alone or in combination with one or more of the first through fourth aspects, the one or more reference signal symbols include a first reference signal symbol and a second reference signal symbol across a phase jump boundary.

In a sixth additional aspect, alone or in combination with one or more of the first through fifth aspects, referencing signal REs of the first reference signal symbol and reference signal REs of the second reference signal symbol are mapped to respective sub-constellations that include points with equal amplitudes and equal point-to-point angles.

In a seventh additional aspect, alone or in combination with one or more of the first through sixth aspects, referencing signal REs of the first reference signal symbol and reference signal REs of the second reference signal symbol are mapped to identical QPSK sequences.

In an eighth additional aspect, alone or in combination with one or more of the first through seventh aspects, referencing signal REs of the first reference signal symbol and reference signal REs of the second reference signal symbol are mapped to QPSK sequences associated with respective sub-constellations in an identical rotational direction.

In a ninth additional aspect, alone or in combination with one or more of the first through eighth aspects, the one or more reference signal symbols include a first reference signal symbol in a first slot associated with a first SLIV and a second reference signal symbol in a second slot associated with a second SLIV.

In a tenth additional aspect, alone or in combination with one or more of the first through ninth aspects, the first reference signal symbol and the second reference signal symbol are associated with equal quantities of layers and identical sets of DMRS ports in accordance with the first reference signal symbol and the second reference signal symbol each including the set of reference signal REs for estimating one or more of the interference or the phase associated with the wireless link.

In an eleventh additional aspect, alone or in combination with one or more of the first through tenth aspects, the first reference signal symbol is associated with more layers than the second reference signal symbol in accordance with the first reference signal symbol including DMRS REs and the second reference signal symbol including reference signal REs of the set of reference signal REs for estimating one or more of the interference or the phase associated with the wireless link and a first set of DMRS ports in the first reference signal symbol being a superset of a second set of DMRS ports in the second reference signal symbol.

Although FIG. 9 shows example blocks of process 900, in some aspects, process 900 may include additional blocks, fewer blocks, different blocks, or differently arranged blocks than those depicted in FIG. 9. Additionally or alternatively, two or more of the blocks of process 900 may be performed in parallel.

FIG. 10 is a flowchart illustrating an example process 1000 performed, for example, at a wireless communication device or an apparatus of a wireless communication device that supports a channel estimation reference signal on a QAM sub-constellation. Example process 1000 is an example where the apparatus or the wireless communication device (for example, UE 120 or network node 110) performs operations associated with cancelling interference or a phase jump from a signal that includes a channel estimation reference signal modulated or otherwise mapped on a QAM sub-constellation.

As shown in FIG. 10, in some aspects, process 1000 may include receiving, over a wireless link, a data message that includes one or more reference signal symbols, wherein the one or more reference signal symbols each include a set of reference signal REs mapped to one or more sub-constellations of a QAM constellation and a set of data REs mapped to the QAM constellation (block 1010). For example, the wireless communication device (such as by using communication manager 1106 or reception component 1102, depicted in FIG. 11, or by using communication manager 1206 or reception component 1202, depicted in FIG. 12) may receive, over a wireless link, a data message that includes one or more reference signal symbols, wherein the one or more reference signal symbols each include a set of reference signal REs mapped to one or more sub-constellations of a QAM constellation and a set of data REs mapped to the QAM constellation, as described above.

As further shown in FIG. 10, in some aspects, process 1000 may include canceling one or more of interference or a phase associated with the wireless link in accordance with the set of reference signal REs (block 1020). For example, the wireless communication device (such as by using communication manager 1106 or cancellation component 1112, depicted in FIG. 12, or by using communication manager 1206 or cancellation component 1212, depicted in FIG. 12) may cancel one or more of interference or a phase associated with the wireless link in accordance with the set of reference signal REs, as described above.

Process 1000 may include additional aspects, such as any single aspect or any combination of aspects described below or in connection with one or more other processes described elsewhere herein.

In a first additional aspect, the set of reference signal REs includes at least a first reference signal RE mapped to a first sub-constellation and a second reference signal RE mapped to a second sub-constellation.

In a second additional aspect, alone or in combination with the first aspect, the data message includes a plurality of layers in which a quantity of ports used to transmit the set of reference signal REs is equal to a quantity of the plurality of layers and less than or equal to a quantity of DMRS ports.

In a third additional aspect, alone or in combination with one or more of the first and second aspects, the plurality of layers corresponds to a plurality of repetitions of the one or more sub-constellations.

In a fourth additional aspect, alone or in combination with one or more of the first through third aspects, the plurality of layers corresponds to a plurality of independent streams of the one or more sub-constellations.

In a fifth additional aspect, alone or in combination with one or more of the first through fourth aspects, the one or more reference signal symbols include a first reference signal symbol and a second reference signal symbol across a phase jump boundary.

In a sixth additional aspect, alone or in combination with one or more of the first through fifth aspects, referencing signal REs of the first reference signal symbol and reference signal REs of the second reference signal symbol are mapped to respective sub-constellations that include points with equal amplitudes and equal point-to-point angles.

In a seventh additional aspect, alone or in combination with one or more of the first through sixth aspects, referencing signal REs of the first reference signal symbol and reference signal REs of the second reference signal symbol are mapped to identical QPSK sequences.

In an eighth additional aspect, alone or in combination with one or more of the first through seventh aspects, referencing signal REs of the first reference signal symbol and reference signal REs of the second reference signal symbol are mapped to QPSK sequences associated with respective sub-constellations in an identical rotational direction.

In a ninth additional aspect, alone or in combination with one or more of the first through eighth aspects, the one or more reference signal symbols include a first reference signal symbol in a first slot associated with a first SLIV and a second reference signal symbol in a second slot associated with a second SLIV.

In a tenth additional aspect, alone or in combination with one or more of the first through ninth aspects, the first reference signal symbol and the second reference signal symbol are associated with equal quantities of layers and identical sets of DMRS ports in accordance with the first reference signal symbol and the second reference signal symbol each including the set of reference signal REs for estimating one or more of the interference or the phase associated with the wireless link.

In an eleventh additional aspect, alone or in combination with one or more of the first through tenth aspects, the first reference signal symbol is associated with more layers than the second reference signal symbol in accordance with the first reference signal symbol including DMRS REs and the second reference signal symbol including reference signal REs of the set of reference signal REs for estimating one or more of the interference or the phase associated with the wireless link and a first set of DMRS ports in the first reference signal symbol being a superset of a second set of DMRS ports in the second reference signal symbol.

Although FIG. 10 shows example blocks of process 1000, in some aspects, process 1000 may include additional blocks, fewer blocks, different blocks, or differently arranged blocks than those depicted in FIG. 10. Additionally or alternatively, two or more of the blocks of process 1000 may be performed in parallel.

FIG. 11 is a diagram of an example apparatus 1100 for wireless communication that supports a channel estimation reference signal on a QAM sub-constellation. The apparatus 1100 may be a wireless communication device, or a wireless communication device may include the apparatus 1100. In some aspects, the apparatus 1100 includes a reception component 1102, a transmission component 1104, and a communication manager 1106, which may be in communication with one another (for example, via one or more buses). As shown, the apparatus 1100 may communicate with another apparatus 1108 (such as a UE 120, a network node 110, or another wireless communication device) using the reception component 1102 and the transmission component 1104. The communication manager 1106 may be included in, or implemented via, a processing system (for example, the processing system 140). In some aspects, the communication manager 1106 is the communication manager 150.

In some aspects, the apparatus 1100 may be configured to or operable to perform one or more operations described herein in connection with FIGS. 7-8. Additionally or alternatively, the apparatus 1100 may be configured to or operable to perform one or more processes described herein, such as process 900 of FIG. 9, process 1000 of FIG. 10, or a combination thereof.

The reception component 1102 may receive communications, such as reference signals, control information, or data communications, from the apparatus 1108. The reception component 1102 may provide received communications to one or more other components of the apparatus 1100, such as the communication manager 1106. In some aspects, the reception component 1102 may perform signal processing on the received communications, and may provide the processed signals to the one or more other components in a similar manner as described above in connection with FIG. 1. In some aspects, the reception component 1102 may include one or more components of the UE 120 described above in connection with FIG. 1, such as a radio, one or more RF chains, one or more transceivers, or one or more modems, each of which may in turn be coupled with one or more antennas of the wireless communication device.

The transmission component 1104 may transmit communications, such as reference signals, control information, or data communications, to the apparatus 1108. In some aspects, the communication manager 1106 may generate communications and may transmit the generated communications to the transmission component 1104 for transmission to the apparatus 1108. In some aspects, the transmission component 1104 may perform signal processing on the generated communications, and may transmit the processed signals to the apparatus 1108 in a similar manner as described above in connection with FIG. 1. In some aspects, the transmission component 1104 may include one or more components of the UE 120 described above in connection with FIG. 1, such as a radio, one or more RF chains, one or more transceivers, or one or more modems, each of which may in turn be coupled with one or more antennas of the wireless communication device. In some aspects, the transmission component 1104 may be co-located with the reception component 1102.

The communication manager 1106 may map a set of reference signal REs for estimating one or more of interference or a phase associated with a wireless link to one or more sub-constellations of a QAM constellation. The communication manager 1106 may transmit or may cause the transmission component 1104 to transmit, over the wireless link, a data message that includes one or more reference signal symbols, wherein the one or more reference signal symbols each include the set of reference signal REs mapped to the one or more sub-constellations and a set of data REs mapped to the QAM constellation. In some aspects, the communication manager 1106 may perform one or more operations described elsewhere herein as being performed by one or more components of the communication manager 1106.

The communication manager 1106 may receive or may cause the reception component 1102 to receive, over a wireless link, a data message that includes one or more reference signal symbols, wherein the one or more reference signal symbols each include a set of reference signal REs mapped to one or more sub-constellations of a QAM constellation and a set of data REs mapped to the QAM constellation. The communication manager 1106 may cancel one or more of interference or a phase associated with the wireless link in accordance with the set of reference signal REs. In some aspects, the communication manager 1106 may perform one or more operations described elsewhere herein as being performed by one or more components of the communication manager 1106.

In some aspects, the communication manager 1106 includes a set of components, such as a mapping component 1110 or a cancellation component 1112. Alternatively, the set of components may be separate and distinct from the communication manager 1106. As used herein, the term “component” is intended to be broadly construed as hardware or a combination of hardware and at least one of software or firmware. In some aspects, one or more components of the set of components may include or may be implemented within a processing system (for example, the processing system 140). Additionally or alternatively, one or more components of the set of components may be implemented at least in part as software stored in one or more memories (for example, the memory described with reference to FIG. 1). For example, a component (or a portion of a component) may be implemented as instructions or code stored in a non-transitory computer-readable medium and executable by the processing system to perform the functions or operations of the component.

The mapping component 1110 may map a set of reference signal REs for estimating one or more of interference or a phase associated with a wireless link to one or more sub-constellations of a QAM constellation. The transmission component 1104 may transmit, over the wireless link, a data message that includes one or more reference signal symbols, wherein the one or more reference signal symbols each include the set of reference signal REs mapped to the one or more sub-constellations and a set of data REs mapped to the QAM constellation.

The reception component 1102 may receive, over a wireless link, a data message that includes one or more reference signal symbols, wherein the one or more reference signal symbols each include a set of reference signal REs mapped to one or more sub-constellations of a QAM constellation and a set of data REs mapped to the QAM constellation. The cancellation component 1112 may cancel one or more of interference or a phase associated with the wireless link in accordance with the set of reference signal REs.

The quantity and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally or alternatively, a set of (one or more) components shown in FIG. 11 may perform one or more functions described as being performed by another set of components shown in FIG. 11.

FIG. 12 is a diagram of an example apparatus 1200 for wireless communication that supports a channel estimation reference signal on a QAM sub-constellation. The apparatus 1200 may be a wireless communication device, or a wireless communication device may include the apparatus 1200. In some aspects, the apparatus 1200 includes a reception component 1202, a transmission component 1204, and a communication manager 1206, which may be in communication with one another (for example, via one or more buses). As shown, the apparatus 1200 may communicate with another apparatus 1208 (such as a UE 120, a network node 110, or another wireless communication device) using the reception component 1202 and the transmission component 1204. The communication manager 1206 may be included in, or implemented via, a processing system (for example, the processing system 145). In some aspects, the communication manager 1206 is the communication manager 155.

In some aspects, the apparatus 1200 may be configured to or operable to perform one or more operations described herein in connection with FIGS. 7-8. Additionally or alternatively, the apparatus 1200 may be configured to or operable to perform one or more processes described herein, such as process 900 of FIG. 9, process 1000 of FIG. 10, or a combination thereof.

The reception component 1202 may receive communications, such as reference signals, control information, or data communications, from the apparatus 1208. The reception component 1202 may provide received communications to one or more other components of the apparatus 1200, such as the communication manager 1206. In some aspects, the reception component 1202 may perform signal processing on the received communications, and may provide the processed signals to the one or more other components in a similar manner as described above in connection with FIG. 1. In some aspects, the reception component 1202 may include one or more components of the network node 110 described above in connection with FIG. 1, such as a radio, one or more RF chains, one or more transceivers, or one or more modems, each of which may in turn be coupled with one or more antennas of the wireless communication device.

The transmission component 1204 may transmit communications, such as reference signals, control information, or data communications, to the apparatus 1208. In some aspects, the communication manager 1206 may generate communications and may transmit the generated communications to the transmission component 1204 for transmission to the apparatus 1208. In some aspects, the transmission component 1204 may perform signal processing on the generated communications, and may transmit the processed signals to the apparatus 1208 in a similar manner as described above in connection with FIG. 1. In some aspects, the transmission component 1204 may include one or more components of the network node 110 described above in connection with FIG. 1, such as a radio, one or more RF chains, one or more transceivers, or one or more modems, each of which may in turn be coupled with one or more antennas of the wireless communication device. In some aspects, the transmission component 1204 may be co-located with the reception component 1202.

The communication manager 1206 may map a set of reference signal REs for estimating one or more of interference or a phase associated with a wireless link to one or more sub-constellations of a QAM constellation. The communication manager 1206 may transmit or may cause the transmission component 1204 to transmit, over the wireless link, a data message that includes one or more reference signal symbols, wherein the one or more reference signal symbols each include the set of reference signal REs mapped to the one or more sub-constellations and a set of data REs mapped to the QAM constellation. In some aspects, the communication manager 1206 may perform one or more operations described elsewhere herein as being performed by one or more components of the communication manager 1206.

The communication manager 1206 may receive or may cause the reception component 1202 to receive, over a wireless link, a data message that includes one or more reference signal symbols, wherein the one or more reference signal symbols each include a set of reference signal REs mapped to one or more sub-constellations of a QAM constellation and a set of data REs mapped to the QAM constellation. The communication manager 1206 may cancel one or more of interference or a phase associated with the wireless link in accordance with the set of reference signal REs. In some aspects, the communication manager 1206 may perform one or more operations described elsewhere herein as being performed by one or more components of the communication manager 1206.

In some aspects, the communication manager 1206 includes a set of components, such as a mapping component 1210 or a cancellation component 1220. Alternatively, the set of components may be separate and distinct from the communication manager 1206. As used herein, the term “component” is intended to be broadly construed as hardware or a combination of hardware and at least one of software or firmware. In some aspects, one or more components of the set of components may include or may be implemented within a processing system (for example, the processing system 145). Additionally or alternatively, one or more components of the set of components may be implemented at least in part as software stored in one or more memories (for example, the memory described with reference to FIG. 1). For example, a component (or a portion of a component) may be implemented as instructions or code stored in a non-transitory computer-readable medium and executable by the processing system to perform the functions or operations of the component.

The mapping component 1210 may map a set of reference signal REs for estimating one or more of interference or a phase associated with a wireless link to one or more sub-constellations of a QAM constellation. The transmission component 1204 may transmit, over the wireless link, a data message that includes one or more reference signal symbols, wherein the one or more reference signal symbols each include the set of reference signal REs mapped to the one or more sub-constellations and a set of data REs mapped to the QAM constellation.

The reception component 1202 may receive, over a wireless link, a data message that includes one or more reference signal symbols, wherein the one or more reference signal symbols each include a set of reference signal REs mapped to one or more sub-constellations of a QAM constellation and a set of data REs mapped to the QAM constellation. The cancellation component 1212 may cancel one or more of interference or a phase associated with the wireless link in accordance with the set of reference signal REs.

The quantity and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally or alternatively, a set of (one or more) components shown in FIG. 12 may perform one or more functions described as being performed by another set of components shown in FIG. 12.

The following provides an overview of some Aspects of the present disclosure:
Aspect 1: A method of wireless communication performed by a wireless communication device, comprising: mapping a set of reference signal REs for estimating one or more of interference or a phase associated with a wireless link to one or more sub-constellations of a QAM constellation; and transmitting, over the wireless link, a data message that includes one or more reference signal symbols, wherein the one or more reference signal symbols each include the set of reference signal REs mapped to the one or more sub-constellations and a set of data REs mapped to the QAM constellation.
Aspect 2: The method of Aspect 1, wherein the set of reference signal REs includes at least a first reference signal RE mapped to a first sub-constellation and a second reference signal RE mapped to a second sub-constellation.
Aspect 3: The method of any of Aspects 1-2, wherein the data message includes a plurality of layers in which a quantity of ports used to transmit the set of reference signal REs is equal to a quantity of the plurality of layers and less than or equal to a quantity of DMRS ports.
Aspect 4: The method of Aspect 3, wherein the plurality of layers corresponds to a plurality of repetitions of the one or more sub-constellations.
Aspect 5: The method of Aspect 3, wherein the plurality of layers corresponds to a plurality of independent streams of the one or more sub-constellations.
Aspect 6: The method of any of Aspects 1-5, wherein the one or more reference signal symbols include a first reference signal symbol and a second reference signal symbol across a phase jump boundary.
Aspect 7: The method of Aspect 6, wherein reference signal REs of the first reference signal symbol and reference signal REs of the second reference signal symbol are mapped to respective sub-constellations that include points with equal amplitudes and equal point-to-point angles.
Aspect 8: The method of Aspect 6, wherein reference signal REs of the first reference signal symbol and reference signal REs of the second reference signal symbol are mapped to identical QPSK sequences.
Aspect 9: The method of Aspect 6, wherein reference signal REs of the first reference signal symbol and reference signal REs of the second reference signal symbol are mapped to QPSK sequences associated with respective sub-constellations in an identical rotational direction.
Aspect 10: The method of any of Aspects 1-9, wherein the one or more reference signal symbols include a first reference signal symbol in a first slot associated with a first SLIV and a second reference signal symbol in a second slot associated with a second SLIV.
Aspect 11: The method of Aspect 10, wherein the first reference signal symbol and the second reference signal symbol are associated with equal quantities of layers and identical sets of DMRS ports in accordance with the first reference signal symbol and the second reference signal symbol each including the set of reference signal REs for estimating one or more of the interference or the phase associated with the wireless link.
Aspect 12: The method of Aspect 10, wherein the first reference signal symbol is associated with more layers than the second reference signal symbol in accordance with the first reference signal symbol including DMRS REs and the second reference signal symbol including reference signal REs of the set of reference signal REs for estimating one or more of the interference or the phase associated with the wireless link and a first set of DMRS ports in the first reference signal symbol being a superset of a second set of DMRS ports in the second reference signal symbol.
Aspect 13: A method of wireless communication performed by a wireless communication device, comprising: receiving, over a wireless link, a data message that includes one or more reference signal symbols, wherein the one or more reference signal symbols each include a set of reference signal REs mapped to one or more sub-constellations of a QAM constellation and a set of data REs mapped to the QAM constellation; and cancelling one or more of interference or a phase associated with the wireless link in accordance with the set of reference signal REs.

Aspect 14: The method of Aspect 13, wherein the set of reference signal REs includes at least a first reference signal RE mapped to a first sub-constellation and a second reference signal RE mapped to a second sub-constellation.

Aspect 15: The method of any of Aspects 13-14, wherein the data message includes a plurality of layers in which a quantity of ports used to transmit the set of reference signal REs is equal to a quantity of the plurality of layers and less than or equal to a quantity of DMRS ports.

Aspect 16: The method of Aspect 15, wherein the plurality of layers corresponds to a plurality of repetitions of the one or more sub-constellations.

Aspect 17: The method of Aspect 15, wherein the plurality of layers corresponds to a plurality of independent streams of the one or more sub-constellations.

Aspect 18: The method of any of Aspects 13-17, wherein the one or more reference signal symbols include a first reference signal symbol and a second reference signal symbol across a phase jump boundary.

Aspect 19: The method of Aspect 18, wherein reference signal REs of the first reference signal symbol and reference signal REs of the second reference signal symbol are mapped to respective sub-constellations that include points with equal amplitudes and equal point-to-point angles.

Aspect 20: The method of Aspect 18, wherein reference signal REs of the first reference signal symbol and reference signal REs of the second reference signal symbol are mapped to identical QPSK sequences.

Aspect 21: The method of Aspect 18, wherein reference signal REs of the first reference signal symbol and reference signal REs of the second reference signal symbol are mapped to QPSK sequences associated with respective sub-constellations in an identical rotational direction.

Aspect 22: The method of any of Aspects 13-21, wherein the one or more reference signal symbols include a first reference signal symbol in a first slot associated with a first SLIV and a second reference signal symbol in a second slot associated with a second SLIV.

Aspect 23: The method of Aspect 22, wherein the first reference signal symbol and the second reference signal symbol are associated with equal quantities of layers and identical sets of DMRS ports in accordance with the first reference signal symbol and the second reference signal symbol each including the set of reference signal REs for estimating one or more of the interference or the phase associated with the wireless link.

Aspect 24: The method of Aspect 22, wherein the first reference signal symbol is associated with more layers than the second reference signal symbol in accordance with the first reference signal symbol including DMRS REs and the second reference signal symbol including reference signal REs of the set of reference signal REs for estimating one or more of the interference or the phase associated with the wireless link and a first set of DMRS ports in the first reference signal symbol being a superset of a second set of DMRS ports in the second reference signal symbol.

Aspect 25: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-24.

Aspect 26: An apparatus for wireless communication at a device, the apparatus comprising one or more memories and one or more processors coupled to the one or more memories, the one or more processors configured to cause the device to perform the method of one or more of Aspects 1-24.

Aspect 27: An apparatus for wireless communication, the apparatus comprising at least one means for performing the method of one or more of Aspects 1-24.

Aspect 28: A non-transitory computer-readable medium storing code for wireless communication, the code comprising instructions executable by one or more processors to perform the method of one or more of Aspects 1-24.

Aspect 29: A non-transitory computer-readable medium storing a set of instructions for wireless communication, the set of instructions comprising one or more instructions that, when executed by one or more processors of a device, cause the device to perform the method of one or more of Aspects 1-24.

Aspect 30: A device for wireless communication, the device comprising a processing system that includes one or more processors and one or more memories coupled with the one or more processors, the processing system configured to cause the device to perform the method of one or more of Aspects 1-24.

Aspect 31: An apparatus for wireless communication at a device, the apparatus comprising one or more memories and one or more processors coupled to the one or more memories, the one or more processors individually or collectively configured to cause the device to perform the method of one or more of Aspects 1-24.

Aspect 32: A device comprising a processing system that includes one or more processors and one or more code-storing memories coupled with the one or more processors, the processing system configured to cause the device to perform the method of one or more of Aspects 1-24.

Aspect 33: A device comprising a processing system that includes processor circuitry and code-storing memory circuitry, the processing system configured to cause the device to perform the method of one or more of Aspects 1-24.

It will be apparent that systems or methods described herein may be implemented in different forms of hardware or a combination of hardware and software. A component being configured to perform a function means that the component has a capability to perform the function, and does not require the function to be actually performed by the component, unless noted otherwise.

As used herein, the term “determine” or “determining” can encompass one or more of a wide variety of actions. For example, “determining” can include one or more of calculating, computing, processing, deriving, detecting, estimating, investigating, looking up, inferring, ascertaining, measuring, resolving, selecting, choosing, obtaining, identifying, interpreting, demodulating, decoding, reading, establishing, forming or generating, among other examples. In some such examples, determining can involve a processor performing some type of calculating, computing, deriving, estimating, inferring, ascertaining, resolving, predicting or other processing to obtain one or more numerical values, sets, elements or other information or results. In some other such examples, determining can involve a processor identifying, looking up, investigating or otherwise obtaining some type of value, set, element or other information or result from a table, a data structure, a database or other memory device or location. In some other such examples, determining can involve a processor identifying, interpreting, demodulating, decoding, detecting, reading or otherwise obtaining some type of value, set, element or other information or result signaled in, for example, a received wireless packet. In some other such examples, determining can involve a processor selecting or choosing one or more values, sets, elements or other information or results from a larger set of values, sets elements or other information or results. In some other such examples, determining can involve a processor performing a measurement, such as on a received signal.

As used herein, the articles “a” and “an” are intended to refer to one or more items and may be used interchangeably with “one or more” or “at least one.” As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Additionally, as used herein, a “set” can refer to one or more items, and a “subset” can refer to a whole set or less than the whole set, but not an empty set. “Set,” “group,” and similar terms are intended to include one or more items and may be used interchangeably with “one or more.” Furthermore, as used herein, the term “or” is intended to be interpreted in the inclusive sense (such as when referring to a series) and may be used interchangeably with “and/or,” unless otherwise explicitly indicated (for example, if used in conjunction with “either” or “only one of”). For example, “A or B” may include A only, B only, or a combination of A and B. Also, as used herein, the terms “has,” “have,” “having,” “comprise,” “comprising,” “include” and “including,” and derivatives thereof or similar terms are intended to be open-ended terms that do not limit an element that they modify (for example, an element “having” A also may have B).

As used herein, the phrase “associated with” is intended to be interpreted in the inclusive sense, unless otherwise explicitly indicated. For example, the phrase “associated with” is not to be construed as a reference to a closed set of conditions, factors, criteria, elements, components, or actions, among other examples. Specifically, unless a phrase refers to “associated with only ‘a,’” or the equivalent in context, whatever it is that is “associated with ‘a,’” may be associated with “a” alone or associated with a combination of “a” and one or more other conditions, factors, criteria, elements, components, or actions, among other examples. In various examples, the phrase “associated with” may be interpreted to mean “in association with,” “in accordance with,” “based on,” “based at least in part on,” “as a function of,” “in response to,” “responsive to,” or “using” as appropriate in the relevant context unless otherwise explicitly indicated. Furthermore, what follows the phrase “associated with,” “in association with,” “in accordance with,” “based on,” “based at least in part on,” “as a function of,” “in response to,” “responsive to,” or “using” is not necessarily the focal point or primary factor associated with the limitation preceding the phrase.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A wireless communication device, comprising:
a processing system that includes one or more processors and one or more code-storing memories coupled with the one or more processors, the processing system configured to cause the wireless communication device to:
map a set of reference signal resource elements (REs) for estimating one or more of interference or a phase associated with a wireless link to one or more sub-constellations of a quadrature amplitude modulation (QAM) constellation; and
transmit, over the wireless link, a data message that includes one or more reference signal symbols, wherein the one or more reference signal symbols each include the set of reference signal REs mapped to the one or more sub-constellations and a set of data REs mapped to the QAM constellation.

2. The wireless communication device of claim 1, wherein the set of reference signal REs includes at least a first reference signal RE mapped to a first sub-constellation and a second reference signal RE mapped to a second sub-constellation.

3. The wireless communication device of claim 1, wherein the data message includes a plurality of layers in which a quantity of ports used to transmit the set of reference signal REs is equal to a quantity of the plurality of layers and less than or equal to a quantity of demodulation reference signal (DMRS) ports.

4. The wireless communication device of claim 3, wherein the plurality of layers corresponds to a plurality of repetitions of the one or more sub-constellations.

5. The wireless communication device of claim 3, wherein the plurality of layers corresponds to a plurality of independent streams of the one or more sub-constellations.

6. The wireless communication device of claim 1, wherein the one or more reference signal symbols include a first reference signal symbol and a second reference signal symbol across a phase jump boundary.

7. The wireless communication device of claim 6, wherein reference signal REs of the first reference signal symbol and reference signal REs of the second reference signal symbol are mapped to respective sub-constellations that include points with equal amplitudes and equal point-to-point angles.

8. The wireless communication device of claim 6, wherein reference signal REs of the first reference signal symbol and reference signal REs of the second reference signal symbol are mapped to identical quadrature phase-shift keying (QPSK) sequences.

9. The wireless communication device of claim 6, wherein reference signal REs of the first reference signal symbol and reference signal REs of the second reference signal symbol are mapped to quadrature phase-shift keying (QPSK) sequences associated with respective sub-constellations in an identical rotational direction.

10. The wireless communication device of claim 1, wherein the one or more reference signal symbols include a first reference signal symbol in a first slot associated with a first start and length indicator value (SLIV) and a second reference signal symbol in a second slot associated with a second SLIV.

11. The wireless communication device of claim 10, wherein the first reference signal symbol and the second reference signal symbol are associated with equal quantities of layers and identical sets of demodulation reference signal (DMRS) ports in accordance with the first reference signal symbol and the second reference signal symbol each including the set of reference signal REs for estimating one or more of the interference or the phase associated with the wireless link.

12. The wireless communication device of claim 10, wherein the first reference signal symbol is associated with more layers than the second reference signal symbol in accordance with the first reference signal symbol including demodulation reference signal (DMRS) REs and the second reference signal symbol including reference signal REs of the set of reference signal REs for estimating one or more of the interference or the phase associated with the wireless link and a first set of DMRS ports in the first reference signal symbol being a superset of a second set of DMRS ports in the second reference signal symbol.

13. A wireless communication device, comprising:
a processing system that includes one or more processors and one or more code-storing memories coupled with the one or more processors, the processing system configured to cause the wireless communication device to:
receive, over a wireless link, a data message that includes one or more reference signal symbols, wherein the one or more reference signal symbols each include a set of reference signal resource elements (REs) mapped to one or more sub-constellations of a quadrature amplitude modulation (QAM) constellation and a set of data REs mapped to the QAM constellation; and
cancel one or more of interference or a phase associated with the wireless link in accordance with the set of reference signal REs.

14. The wireless communication device of claim 13, wherein the set of reference signal REs includes at least a first reference signal RE mapped to a first sub-constellation and a second reference signal RE mapped to a second sub-constellation.

15. The wireless communication device of claim 13, wherein the data message includes a plurality of layers in which a quantity of ports used to transmit the set of reference signal REs is equal to a quantity of the plurality of layers and less than or equal to a quantity of demodulation reference signal (DMRS) ports.

16. The wireless communication device of claim 13, wherein the one or more reference signal symbols include a first reference signal symbol and a second reference signal symbol across a phase jump boundary.

17. The wireless communication device of claim 16, wherein reference signal REs of the first reference signal symbol and reference signal REs of the second reference signal symbol are mapped to respective sub-constellations that include points with equal amplitudes and equal point-to-point angles.

18. The wireless communication device of claim 16, wherein reference signal REs of the first reference signal symbol and reference signal REs of the second reference signal symbol are mapped to identical quadrature phase-shift keying (QPSK) sequences or to QPSK sequences associated with respective sub-constellations in an identical rotational direction.

19. The wireless communication device of claim 13, wherein the one or more reference signal symbols include a first reference signal symbol in a first slot associated with a first start and length indicator value (SLIV) and a second reference signal symbol in a second slot associated with a second SLIV.

20. A method for wireless communication by a wireless communication device, comprising:
mapping a set of reference signal resource elements (REs) for estimating one or more of interference or a phase associated with a wireless link to one or more sub-constellations of a quadrature amplitude modulation (QAM) constellation; and
transmitting, over the wireless link, a data message that includes one or more reference signal symbols, wherein the one or more reference signal symbols each include the set of reference signal REs mapped to the one or more sub-constellations and a set of data REs mapped to the QAM constellation.
